(19) United States
(12) Patent Application Publication
(10) Pub. No.: US 2025/0274874 A1
(43) Pub. Date: Aug. 28, 2025

(54) AUTOMATIC FREQUENCY COORDINATION

(71) Applicant: QUALCOMM INCORPORATED, San Diego, CA (US)

(72) Inventors: Parthiban ELLAPPAN, Virudhunagar (IN); Xiaoxin ZHANG, Sunnyvale, CA (US); Rishabh RAJ, Jamshedpur (IN); Zhiqun LIU, Foster City, CA (US); Tevfik YUCEK, San Jose, CA (US)

(21) Appl. No.: 18/587,253

(22) Filed: Feb. 26, 2024

(51) Int. Cl. H04W 52/28; H04W 52/24

(52) U.S. Cl. CPC H04W 52/283; H04W 52/241

(57) ABSTRACT

A method of controlling wireless communication device operation, the method comprising: determining a height of a wireless communication device in response to a horizontal location of the wireless communication device corresponding to a potential transmission regulation zone; determining, based on the horizontal location of the wireless communication device and the height of the wireless communication device, whether the wireless communication device is disposed in a transmission regulation zone relative to a first RAT device (first Radio Access Technology device) and a second RAT device; and providing, based on whether the wireless communication device is disposed in the transmission regulation zone, an indication of transmission power for wireless signal transmission by the wireless communication device.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Communication devices may use a variety of frequencies of communication signals, and may be licensed or unlicensed for use of various frequencies. For example, fixed service devices provide communication services from fixed (stationary) positions and may be licensed for communication in a 6 GHz band. Other devices, such as access points, may transmit signals in the 6 GHz band but may be unlicensed to do so. The access point transmissions may cause interference with the fixed service device communications if an access point is transmitting in the same band being concurrently used by a fixed service device.

### SUMMARY

An example of controlling wireless communication device operation includes: determining a height of a wireless communication device in response to a horizontal location of the wireless communication device corresponding to a potential transmission regulation zone; determining, based on the horizontal location of the wireless communication device and the height of the wireless communication device, whether the wireless communication device is disposed in a transmission regulation zone relative to a first RAT device (first Radio Access Technology device) and a second RAT device; and providing, based on whether the wireless communication device is disposed in the transmission regulation zone, an indication of transmission power for wireless signal transmission by the wireless communication device.

An example apparatus includes: at least one memory; and at least one processor, communicatively coupled to the at least one memory, configured to: determine a height of a wireless communication device in response to a horizontal location of the wireless communication device corresponding to a potential transmission regulation zone; determine, based on the horizontal location of the wireless communication device and the height of the wireless communication device, whether the wireless communication device is disposed in a transmission regulation zone relative to a first RAT device (first Radio Access Technology device) and a second RAT device; and provide, based on whether the wireless communication device is disposed in the transmission regulation zone, an indication of transmission power for wireless signal transmission by the wireless communication device.

Another example apparatus includes: means for determining a height of a wireless communication device in response to a horizontal location of the wireless communication device corresponding to a potential transmission regulation zone; means for determining, based on the horizontal location of the wireless communication device and the height of the wireless communication device, whether the wireless communication device is disposed in a transmission regulation zone relative to a first RAT device (first Radio Access Technology device) and a second RAT device; and means for providing, based on whether the wireless communication device is disposed in the transmission regulation zone, an indication of transmission power for wireless signal transmission by the wireless communication device.

An example non-transitory, processor-readable storage medium includes processor-readable instructions to cause at least one processor of an apparatus to: determine a height of a wireless communication device in response to a horizontal location of the wireless communication device corresponding to a potential transmission regulation zone; determine, based on the horizontal location of the wireless communication device and the height of the wireless communication device, whether the wireless communication device is disposed in a transmission regulation zone relative to a first RAT device (first Radio Access Technology device) and a second RAT device; and provide, based on whether the wireless communication device is disposed in the transmission regulation zone, an indication of transmission power for wireless signal transmission by the wireless communication device.

### BRIEF DESCRIPTION OF THE DRAWINGS

FIG. 1 is a simplified diagram of an example wireless communications system.

FIG. 2A is a perspective view of components of the system shown in FIG. 1, including access points, fixed service devices, an automatic frequency coordination device, and a line of sight between the fixed services devices.

FIG. 2B is a perspective view of the fixed services devices shown in FIG. 2A and a Fresnel Zone between the fixed services devices.

FIG. 2C is a top view of FIG. 2A, showing a footprint of the Fresnel Zone shown in FIG. 2B.

FIG. 2D is a perspective view of the fixed services devices shown in FIG. 2A and a directional beam between the fixed services devices.

FIG. 2E is a top view of FIG. 2A, showing a footprint of the directional beam shown in FIG. 2D.

FIG. 2F is a perspective view of the fixed services devices shown in FIG. 2A and a cylinder between the fixed services devices.

FIG. 2G is a top view of FIG. 2A, showing a footprint of the directional beam shown in FIG. 2F.

FIG. 2H is a perspective view of the fixed services devices shown in FIG. 2A and a sphere disposed about one of the fixed services devices.

FIG. 2I is a top view of FIG. 2A, showing a footprint of the sphere shown in FIG. 2H.

FIG. 3 is a block diagram of components of an example transmission/reception point.

FIG. 4 is a block diagram of components of an automatic frequency coordination device.

FIG. 5 is a simplified block diagram of an example apparatus.

FIG. 6 is block flow diagram of a method of access point operation.

FIG. 7 is a block diagram of an access point and a reference device and a relationship therebetween.

FIG. 8 is a block diagram of an environment including a mobile access point and multiple reference devices.

FIG. 9 is a block diagram of an access point and two fixed service devices, a relationship between the fixed service devices, and a relationship between one of the first service devices and the access point.

FIG. 10 is signaling and process flow diagram for controlling wireless communication device operation.

FIG. 11 is a block flow diagram of a method of controlling wireless communication device operation.

FIG. 12 is a block diagram of an example wireless communication device.

### DETAILED DESCRIPTION

Techniques are discussed herein for operation of an access point. For example, a control apparatus (e.g., a server, a wireless communication device, an Automatic Frequency Coordination apparatus, etc.) may obtain an accurate two-dimensional location (e.g., latitude and longitude) of a subject apparatus (e.g., a wireless communication device such as an access point) and determine whether the subject apparatus is disposed at a two-dimensional potential-interference location. For example, the potential-interference location may be on a footprint of a line of sight (LOS) between RAT devices (Radio Access Technologies devices), or within a footprint of a Fresnel zone between RAT devices (Radio Access Technology devices such as fixed-location devices such as Fixed Service (FS) devices), or within a footprint of a directional beam (e.g., within a threshold beamwidth of the directional beams such as a 3 dB beamwidth (or a 5 dB beamwidth, or a 10 dB beamwidth) of the directional beam) from a RAT device. If the subject apparatus is disposed in a potential-interference location, then the control apparatus may request an elevation (height) of the subject apparatus to determine whether a three-dimensional location of the subject apparatus is at a three-dimensional potential-interference location, e.g., on the LOS or in the Fresnel Zone or within the threshold beamwidth. If the subject apparatus is in the three-dimensional potential-interference location, then the control apparatus may transmit an instruction to the subject apparatus regarding transmit power used by the subject apparatus. For example, the instruction may be for the subject apparatus to transmit, if at all, a first signal of a potentially-interfering frequency (e.g., in a same frequency band as (e.g., at the same frequency as), or of a harmonic of a frequency of) a second signal (that may be transferred between the RAT devices) with a power level that will induce no more than an acceptable level of interference with the second signal. The instruction may indicate for the subject apparatus to avoid transmitting the first signal (i.e., not to transmit the first signal), or to transmit the first signal with reduced (i.e., less than a threshold (e.g., standard)) power. If the subject apparatus is not disposed in the three-dimensional potential-interference location, then the control apparatus may determine whether the subject apparatus is within a threshold distance a RAT device. If the subject apparatus is not within the threshold distance of a RAT device, then the control apparatus may allow (e.g., instruct) the subject apparatus to transmit the first signal at standard power (e.g., above the threshold power). If the subject apparatus is within the distance threshold of at least one RAT device, then the control apparatus may determine whether a SIPR (Signal-to-Interference Power Ratio) with the subject apparatus transmitting at a relatively higher power level (e.g., a standard power level) is below an SIPR threshold. If the SIPR is above the SIPR threshold, then the control apparatus may allow the subject apparatus to transmit the first signal with power above the threshold power, and otherwise may instruct the subject apparatus to avoid transmitting the first signal with more than the threshold power (e.g., to transmit at a reduced power, below the standard power level). Other techniques, however, may be used.

Items and/or techniques described herein may provide one or more of the following capabilities, as well as other capabilities not mentioned. An accurate height estimation of subject apparatus may be obtained and used to determine whether the subject apparatus is at a three-dimensional potential-interference location. Accurate height estimation may be obtained when at least one of the subject apparatus and a reference device (e.g., an access point, a fixed service device, etc.) supports angle-of-arrival measurement. Accurate height estimation may be obtained when neither the subject apparatus nor the reference device supports angle-of-arrival measurement. Operation of a subject apparatus that is within a three-dimensional potential-interference location may be controlled to help avoid interference by the subject apparatus with signaling from a RAT device with a directional beam. Potential interference by a subject apparatus that is not within a three-dimensional potential-interference location may be identified, and operation of the subject apparatus may be controlled to help avoid interference by the subject apparatus with signal transmission and/or signal reception by the RAT device. Successful signal transmission and/or reception by a directional-beam RAT device, e.g., communication between fixed service devices, may be improved, e.g., by reducing or eliminating interference caused by one or more subject apparatus, while facilitating subject apparatus use where the subject apparatus is unlikely to interfere with signal transmission and/or reception by a directional-beam RAT device. Other capabilities may be provided and not every implementation according to the disclosure must provide any, let alone all, of the capabilities discussed.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

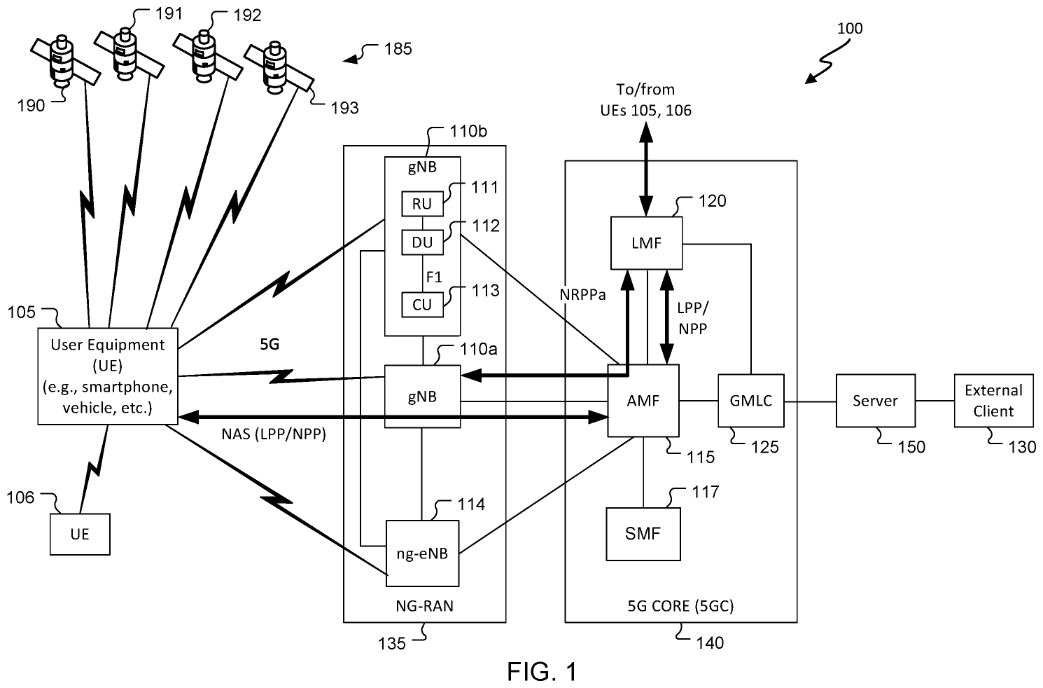

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above a reference level such as mean sea level, ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below a reference level, e.g., mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (ELTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

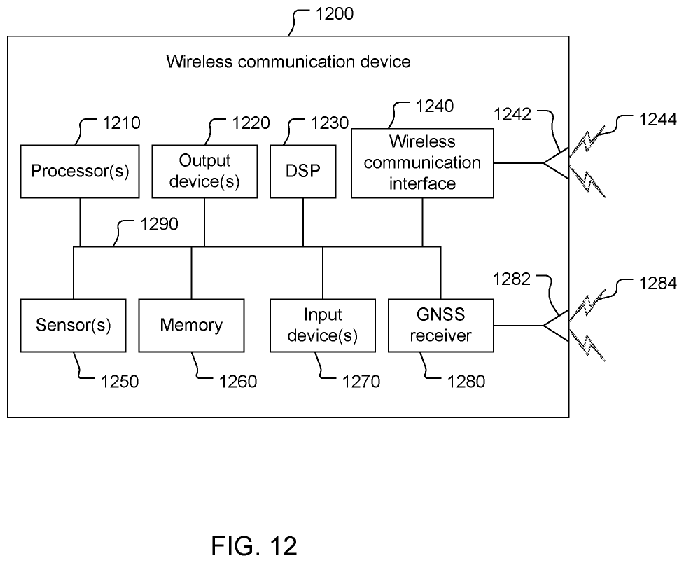

Referring also to FIG. 12, a wireless communication device 1200, which is an example of the 105, includes one or more processors 1210, one or more output devices 1220, a DSP 1230 (Digital Signal Processor), a wireless communication interface 1240, one or more sensors 1250, a memory 1260, one or more input devices 1270, and a GNSS receiver 1280, communicatively coupled to each other by a bus 1290. The processor(s) 1210 may include one or more general-purpose processors, one or more special-purpose processors (such as DSP chips, graphics acceleration processors, application specific integrated circuits (ASICs), and/or the like), and/or other processing structures or means. The output device(s) 1220 may include a display, a light emitting diode (LED), and/or one or more speakers, and/or the like. The DSP 1230 may be separate from the processor(s) 1210 or included in the processor(s) 1210, e.g., depending on desired functionality. Location determination and/or other determinations based on wireless communication may be provided in the processor(s) 1210 and/or the wireless communication interface 1240 (discussed below). The sensor(s) 1250 may include one or more inertial sensors and/or one or more other sensors (e.g., accelerometer(s), gyroscope(s), camera(s), magnetometer(s), altimeter(s), microphone(s), proximity sensor(s), light sensor(s), barometer(s), etc.), some of which may be used to obtain position-related measurements and/or other information, as described herein. The memory 1260 may include local and/or network accessible storage, a disk drive, a drive array, an optical storage device, a solid-state storage device, such as a random access memory (RAM), and/or a read-only memory (ROM), which can be programmable, flash-updateable, etc. Such storage devices may be configured to implement any appropriate data stores, including without limitation, various file systems, database structures, etc. The input device(s) 1270 may include a keyboard, a touch screen, a touch pad, a microphone, one or more buttons, one or more dials, and/or one or more switches, and/or the like. The GNSS receiver 1280 may be configured to determine a location of the wireless communication device 1200 based on received GNSS signals.

The wireless communication interface 1240 may be configured to transmit and/or receive a variety of wireless signals 1244 via an antenna 1242. The wireless communication interface 1240 comprise a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.). The wireless communication interface 1240 may permit data and signaling to be communicated (e.g., transmitted and/or received) with a network, for example, via eNBs, gNBs, ng-eNBs, access points, various base stations and/or other access node types, TRPs, and/or other network components, computer systems, and/or any other appropriate electronic devices. The antenna 1242 may comprise one or more discrete antennas, one or more antenna arrays, or any combination thereof.

Depending on desired functionality, the wireless communication interface 1240 may comprise a separate receiver and transmitter, or any combination of transceivers, transmitters, and/or receivers to communicate with base stations (e.g., ng-eNBs and gNBs) and other terrestrial transceivers, such as wireless devices and access points. The wireless communication interface 1240 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, etc. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000 is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. Techniques described herein may be used for any combination of WWAN, WLAN and/or WPAN.

The memory 1260 may comprise one or more software elements (not shown). The software element(s) may include an operating system, device drivers, executable libraries, and/or other code, such as one or more application programs, which may comprise computer programs provided by various examples, and/or may be designed to implement methods, and/or configure systems, provided by other examples, as described herein. One or more procedures described with respect to the method(s) discussed herein may be implemented as code and/or instructions in the memory 1260 that are executable by the processor(s) 1210 and/or the DSP 1230).

The GNSS receiver 1280 may be capable of receiving GNSS signals 1284 from one or more GNSS satellites via an antenna 1282 (which could be the antenna 1242). Positioning based on GNSS signal measurement may be utilized to complement and/or incorporate techniques described herein. The GNSS receiver 1280 may be configured to determine a position of the wireless communication device 1200 using conventional techniques, from the constellation 185 of GNSS SVs, such as Global Positioning System (GPS), Galileo, GLONASS, Quasi-Zenith Satellite System (QZSS) over Japan, Indian Regional Navigational Satellite System (IRNSS) over India, Beidou over China, etc. The GNSS receiver 1280 may be used with various augmentation systems (e.g., a Satellite Based Augmentation System (SBAS)) that may be associated with or otherwise enabled for use with one or more global and/or regional navigation satellite systems, such as, e.g., WAAS, EGNOS, Multi-functional Satellite Augmentation System (MSAS), and Geo Augmented Navigation system (GAGAN), etc.

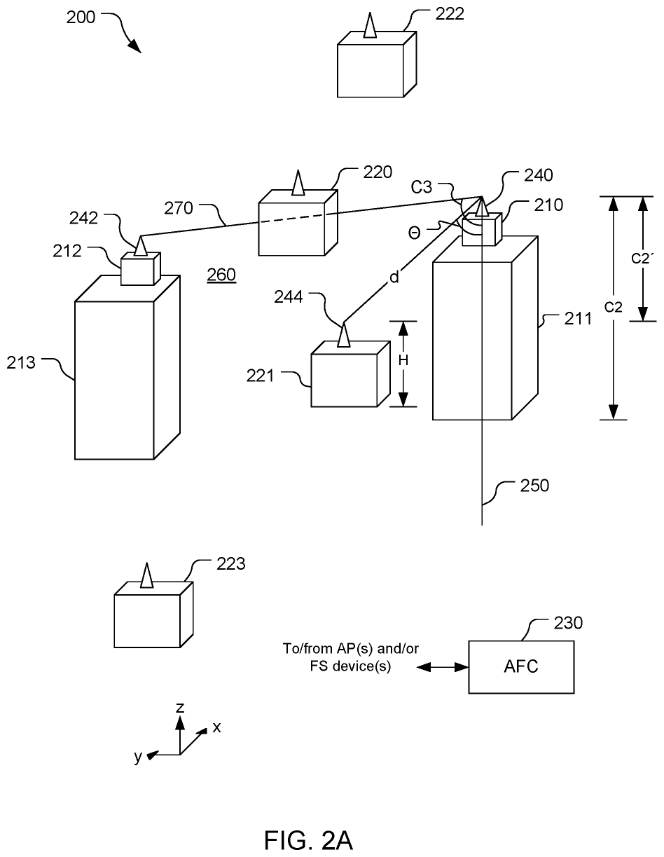

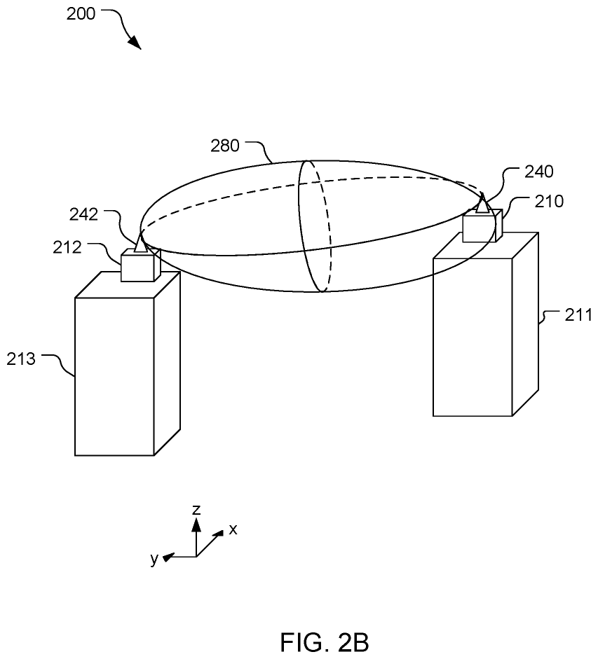

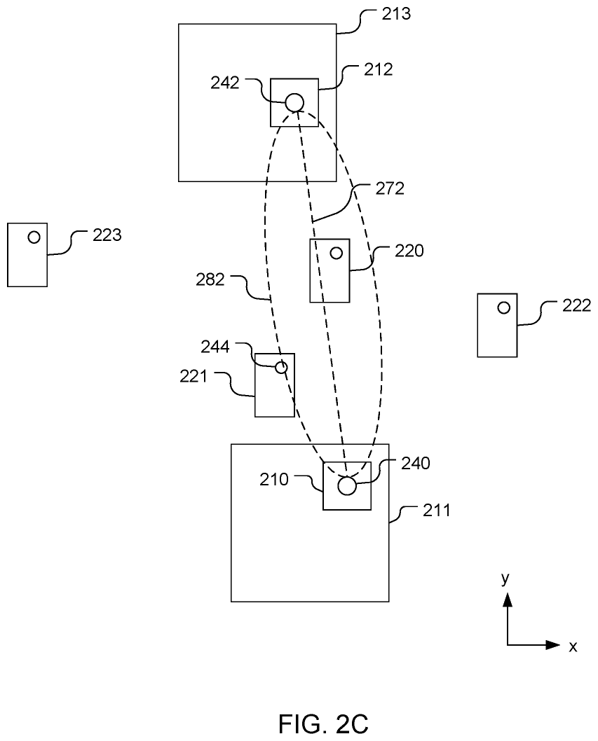

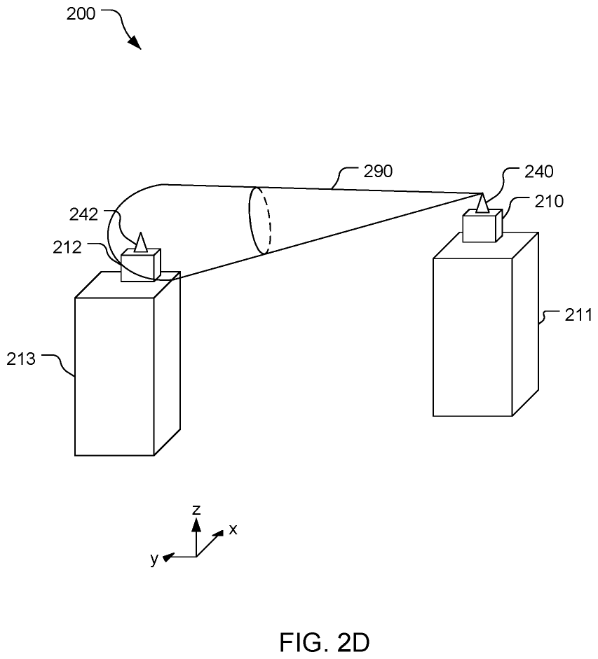

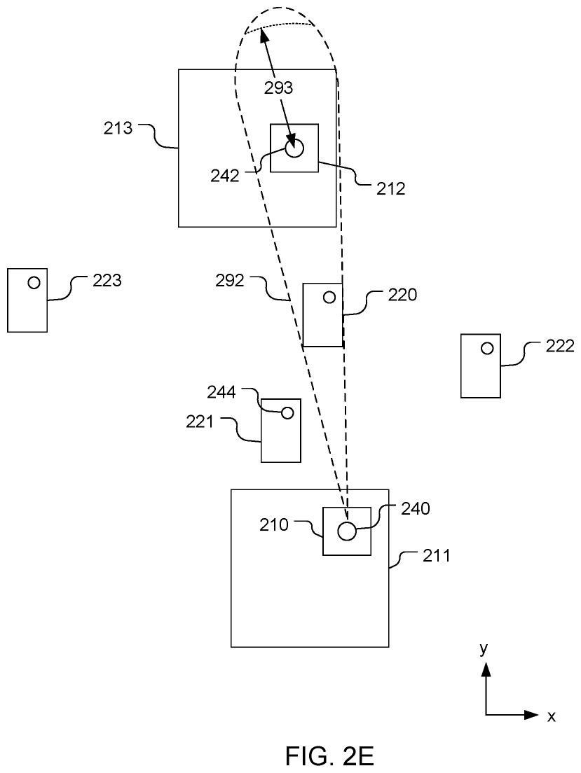

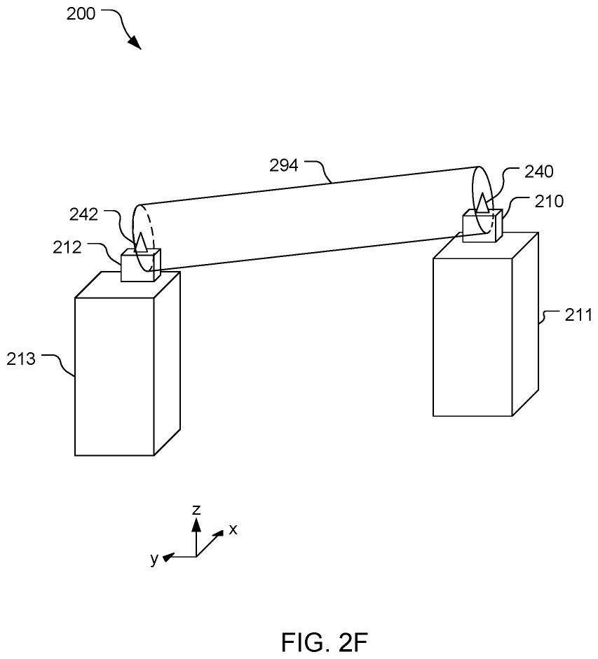

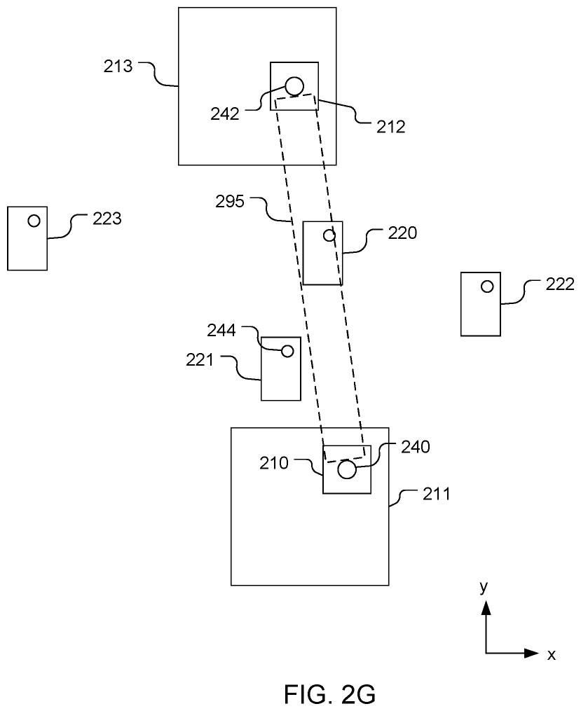

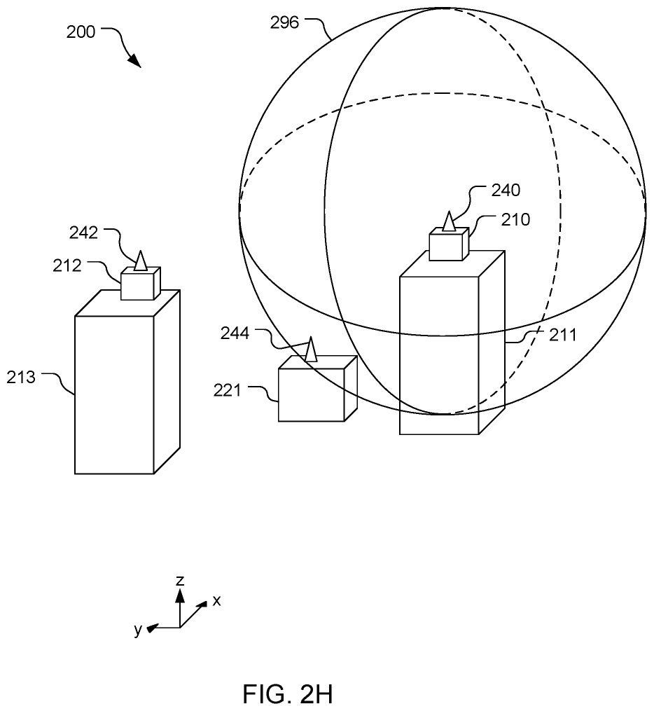

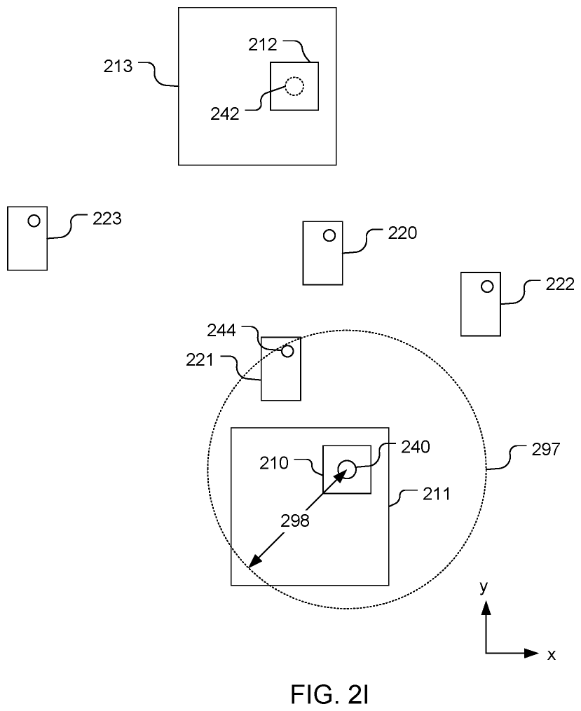

Referring also to FIG. 2A, a communication environment 200 includes RAT (Radio Access Technology) devices, here FS devices 210, 212 (fixed service devices), subject apparatus, here APs 220, 221, 222, 223 (access points), and an AFC 230 (Automatic Frequency Coordination device). The subject apparatus are wireless communication devices, such as the wireless communication device 1200. Each of the directional-beam RAT devices may be configured to produce at least one directional antenna beam (and thus be a directional-beam RAT device), and may be a fixed location device. Examples of directional-beam RAT devices include millimeter-wave devices (mmW devices) and monostatic sensing system devices (e.g., monostatic WiFi® radar). A directional beam may not be a fixed beam, but may be a swept beam such that the direction of the directional beam changes over time. The description herein uses the example of the RAT devices being directional-beam RAT devices, in particular being directional-beam FS devices, but other types of devices may be used (e.g., devices other than FS devices, RAT devices that are not directional-beam RAT devices, or that are RAT devices that may produce a directional beam but do not produce a directional beam). Non-directional-beam RAT devices may include, for example, UWB (Ultra Wideband) devices, Bluetooth® devices and/or WiFi® devices (and/or other short-range wireless protocol devices), etc. Such devices may include access points and/or repeaters (e.g., for providing whole-house WiFi®). Techniques discussed herein may be used, e.g., to determine whether to regulate, and to regulate, signal transmission by a mobile device (e.g., to locate an IoT (Internet of Things) tag for tracking/locating an object) based on whether the signal transmission may interfere with communication between non-directional RAT devices. The FS devices 210, 212 may be stationary radiocommunication devices configured to provide radiocommunications between fixed (stationary) points, in this example, from tops of respective buildings 211, 213. While the discussion herein focuses on access points and fixed services devices, the discussion is applicable to other types of wireless communication devices, e.g., other subject apparatus that operate in a 6 GHz band, support angle of arrival measurement, and/or support round-trip time measurement, and/or other pairs of signal transfer devices. One or more of the APs 220-223 may be mobile. One or more of the APs 220-223 may be configured to determine its own location, e.g., being equipped with an SPS receiver configured to receive and measure SV signals and determine a location through trilateration based on pseudoranges determined from the SV signals. The AFC 230 may be configured to coordinate operation of the APs 220-223 and the FS devices 210, 212, e.g., to help avoid interference with signal transfer between the FS devices 210, 212. The AFC 230 may be separate from the FS devices 210, 212 and the APs 220-223 as shown, or may be incorporated into one or more of the APs 220-223 and/or one or more of the FS devices 210, 212.

One or more of the APs 220-223 may negatively affect communication between the FS devices 210, 212 by being in a signal transmission regulation zone 260 and transmitting a first signal of sufficient transmit power to cause an undesired (e.g., unacceptable) level interference with a second signal transmitted by at least one of the FS devices 210, 212. The first signal would be of a potentially interfering frequency, e.g., of the same frequency as the second signal, in a same frequency band as the second signal, or a harmonic thereof. The FS devices 210, 212 and one or more of the APs 220-223 may transmit signals in the same frequency band, e.g., the licensed 6 GHz band even though the FS devices 210, 212 may be licensed to use this band and the AP(s) 220-223 may not be licensed to use this band. The signal transmission regulation zone 260 may be a one-dimensional or a three-dimensional region in which transmission of the first signal may be regulated, e.g., because transmission of the first signal within the zone 260 may cause an undesired level (e.g., above a threshold level) of interference with the signal (e.g., causing a SIPR (Signal-to-Interference Power Ratio) to be below a threshold SIPR). For example, one or more of the APs 220-223 may disrupt an LOS 270 (line-of-sight) between the devices 210, 212. As another example, even if an AP does not interrupt the LOS (i.e., is non-line-of-sight (NLOS)) between the devices 210, 212, the AP may be close enough to the LOS 270 and may transmit a signal with sufficient signal power and of a potentially interfering to interfere with signal transfer between the devices 210, 212. As non-exhaustive examples, the AP (or other subject apparatus) may be, as shown in FIG. 2B, within a Fresnel Zone 280 between the devices 210, 212, or may be, as shown in FIG. 2D, within an interference portion of a directional beam 290 (e.g., a threshold beamwidth, e.g., 3 dB beamwidth, 5 dB beamwidth, or 10 dB beamwidth of a directional beam), or may be, as shown in FIG. 2F, within a cylinder 294 (or region of another shape). As another example, even if an AP does not interrupt the LOS 270 and is displaced significantly from the LOS 270 (e.g., outside the Fresnel Zone 280, outside the interference portion of the directional beam 290 (from each of the devices 210, 212), and outside the cylinder 294) and within a threshold distance of at least one of the devices 210, 212 (e.g., within a sphere 296 as shown in FIG. 2H), the AP may be close enough to one of the devices 210, 212 and may transmit a signal with sufficient signal power and of a potentially interfering frequency to interfere with signal transfer between the devices 210, 212, e.g., to render a SIPR below a threshold SIPR. The signal transmission regulation zone 260 may thus include, for example, the Fresnel Zone 280, and/or one or more regions corresponding to an interference portion of a directional beam (such as a portion of the directional beam 290 within range of inducing unacceptable interference to at least one of the devices 210, 212), and/or one or more regions such as the sphere 296 within which signal transmission may induce an unacceptable SIPR for at least one of the devices 210, 212, even if signal transmission in some portions of the sphere 296 may not induce an unacceptable SIPR for at least one of the devices 210, 212. The sphere 296 (or other shape) may be overly large to include a volume in which interference is theoretically possible even if not realistic or possible in some portions of the volume in a particular environment, e.g., due to particular device features, e.g., antenna gain. With the signal transmission regulation zone 260 the Fresnel Zone 280 and the sphere 296 at each of the devices 210, 212, a shape of the signal transmission regulation zone 260 would be a portion of an ellipsoid joined on either end to a sphere. Various types of devices may provide a directional beam. For example, an FS device, a millimeter-wave device, or a monostatic sensing device may provide a directional beam. A direction of a directional beam may be changed over time, e.g., to provide beam sweeping.

Determining whether an access point is disposed in the signal transmission regulation zone 260 may be desirable. Determining whether an access point is disposed in the signal transmission regulation zone 260 (a three-dimensional potential-interference location) may be a two-step process, determining whether the access point overlaps with a footprint of the signal transmission regulation zone 260 (e.g., of the LOS 270, of the Fresnel Zone 280, of an interference portion of the directional beam 290 (or another directional beam), or a region (e.g., the sphere 296) close to at least one of the devices 210, 212), and if so, then determining whether the access point is in the signal transmission regulation zone 260 by determining a height of the access point in addition to the horizontal location and, if appropriate, determining an effect on SIPR of the access point. For example, determining whether an access point interrupts line-of-sight between the FS devices 210, 212 may be a two-step process. Referring also to FIG. 2C, a horizontal location (a two-dimensional, x-y, surface-of-the-Earth location) of each of the APs 220-223 may be determined and compared to a footprint 272 of the LOS 270 (i.e., a projection of the LOS 270 onto the surface of the Earth) between the FS devices 210, 212. If the horizontal location does not overlap with the footprint 272 of the LOS 270, then the access point (e.g., the APs 221-223) may be determined to be outside of the LOS 270. If the horizontal location (e.g., as for the AP 220) is determined to overlap with the footprint 272 of the LOS 270, then determining whether the access point interrupts the LOS 270 may rely on determining height, as discussed further below, of the access point in addition to the horizontal position of the access point. Similarly, determining whether an access point is disposed in the Fresnel Zone 280 may comprise determining whether the horizontal location of the access point overlaps with a footprint 282 of the Fresnel Zone 280. If the horizontal location does not overlap with the footprint 282 of the Fresnel Zone 280, then the access point (e.g., the APs 222, 223) may be determined to be outside of the Fresnel Zone 280. If the horizontal location (e.g., as for the APs 220, 221) is determined to overlap with the footprint 282 of the Fresnel Zone 280, then determining whether the access point is in the Fresnel Zone 280 may rely on determining height of the access point. Similarly, referring also to FIG. 2E, determining whether an access point is disposed in an interference portion of the directional beam 290 may comprise determining whether the horizontal location of the access point overlaps with an interference portion footprint 292 of the directional beam 290 up to the FS device 212. If the horizontal location does not overlap with the interference portion footprint 292 of the directional beam 290, then the access point (e.g., the APs 221-223) may be determined to be outside of the interference portion of the directional beam 290. If the horizontal location (e.g., as for the AP 220) is determined to overlap with the interference portion footprint 292 of the directional beam 290 (e.g., up to a limit such as the FS device 212 or within a range (e.g., within a distance 293 of the antenna 242) within which the access point may induce an unacceptable level of interference to at least one of the device 210, 212, then determining whether the access point is in the interference portion of the directional beam 290 may rely on determining height of the access point. Similarly, referring also to FIG. 2G, determining whether an access point is disposed in the cylinder 294 (or an interference portion thereof if the cylinder 294 extends beyond one or more of the FS devices 210, 212, e.g., up to a distance such as the distance 293) may comprise determining whether the horizontal location of the access point overlaps with an interference portion footprint 295 of the cylinder 294. If the horizontal location does not overlap with the interference portion footprint 295 of the cylinder 294, then the access point (e.g., the APs 221-223) may be determined to be outside of the cylinder 294. If the horizontal location (e.g., as for the AP 220) is determined to overlap with the interference portion footprint 295 of the cylinder 294 (e.g., up to a limit) within which the access point may induce an unacceptable level of interference to at least one of the device 210, 212, then determining whether the access point is in the cylinder 294 may rely on determining height of the access point. If an access point is determined to be in the LOS 270, then determining whether the access point is in the Fresnel Zone 280, or the directional beam 290, or the cylinder 294 may be omitted. Also or alternatively, referring also to FIG. 2I, determining whether an access point is disposed in one or more proximate interference regions each near a respective one of the devices 210, 210, such as the sphere 296, or another (e.g., irregularly-shaped) region within which signal transmission by an access point may induce an unacceptable SIPR for at least one of the devices 210, 212 may comprise determining whether the horizontal location of the access point overlaps with a footprint of each of the regions, e.g., a footprint 297 of the sphere 296. If the horizontal location does not overlap with the footprint 297 of the sphere 296, then the access point (e.g., the APs 220, 222, 223) may be determined to be outside of the sphere 296 (which is an example of a proximate interference region). If the horizontal location (e.g., as for the AP 221) is determined to overlap with the footprint 297 of the sphere 296, then determining whether the access point is in the proximate interference region, here the sphere 296, may rely on determining height of the access point and/or assessing a SIPR based on the access point (which may also involve determining the height of the access point). A radius 298 of the sphere 296, and thus also of the footprint 297, may be equal to the distance 293. The footprint 297 may be larger than a footprint of an SIPR region within which signal transmission by an access point may induce an unacceptable SIPR for at least one of the devices 210, 212. The SIPR region may be irregularly shaped due to dependence on various factors, including antenna gain, as discussed further below.

Determining an estimate of height above a reference level typically involves dedicated hardware that some access points do not have, e.g., due to the expense of the hardware. For example, examples of hardware for determining height are SPS receivers and barometric pressure sensors. Further, professional installation of hardware may increase the cost. In a network, typically some APs are equipped with height-determining hardware and some APs are not equipped with height-determining hardware. Accurately determining height of devices that may interfere with LOS point-to-point operation of FS devices may be important, as inaccurate height estimation may inhibit an incumbent FS device from operating in LOS with another FS device. For example, in the environment 200, the AP 220 is disposed in the LOS 270 between the FS devices 210, 212, the APs 220, 221 are disposed within the footprint 282 of the Fresnel Zone 280, the AP 220 is disposed within interference portion of the footprint 292 of the directional beam 290, the AP 220 is disposed within the footprint 295 of the cylinder 294, and the AP 221 is disposed within the footprint 297 of the sphere 296, and thus knowing the height (in addition to the latitude and longitude) of the AP 220 and/or the AP 221 may be desirable (depending on the signal transmission regulation zone 260 used). It may thus be desired to determine a height estimation of the AP 220 and/or the AP 221 regardless of whether the AP 220 or the AP 221 has height-estimation hardware (e.g., an SPS receiver) and/or whether the AP 220 or the AP 221 has any other height-estimation limitation (e.g., does not support AoA determination). While a device, e.g., an AP, may be able report a horizontal location with at least 95% confidence that has an error of about +/−1 m, the device may not be able to provide a height estimate with such accuracy, but perhaps with an error of about +/−10 m.

As mentioned above, determining whether an access point that does not interrupt, or come close to interrupting, line-of-sight between the FS devices 210, 212, but may still undesirably interfere with communication between the FS devices 210, 212, may be desirable. An AP that is NLOS (relative to the FS devices 210, 212) or outside of the Fresnel Zone 280 or outside of an interference portion of a directional beam or outside of the cylinder 294 may be in close enough proximity (e.g., within the sphere 296) and transmit a signal with sufficient power to interfere with a signal (in the same frequency band as the AP signal or at a harmonic of the AP signal) to be transferred between the FS devices 210, 212. The interference introduced by an AP, in this example the AP 221, may be a function of a distance between the AP and one of the FS devices 210, 212, and FS device characteristics including link length C1, antenna height C2, elevation angle C3, and antenna gain C4. In this example, the FS device 210 is used as an FS device of interest. The link length C1 is the distance between antennas 240, 242 of the FS devices 210, 212. The antenna height C2 is the height of the antenna 240 relative to a reference level (e.g., average sea level). The elevation angle C3 is the angle, relative to a vertical 250 (i.e., a normal to the idealized surface of the Earth and passing through the antenna 240), of the antenna 242 of the FS device 212 from the antenna 240 of the FS device 210. The antenna gain C4 is the gain of the antenna 240. Additionally, a height (relative to a reference level) of an antenna 244 of the AP 221 is labeled H in FIG. 2. Consequently, a differential height C2′ (also called an incremental height) of the antenna 240 relative to the height H of the antenna 244 may be represented as C2′=C2−H. The FS device characteristics are specific to the FS device (C2, C4) and the combination of FS devices (C1, C3) between which there is to be communication.

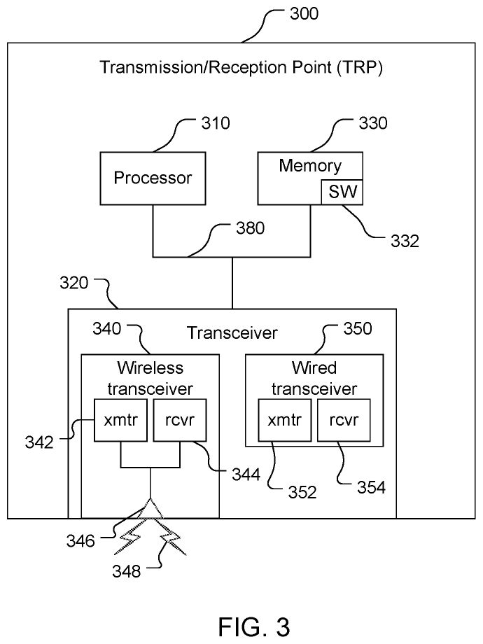

Referring also to FIG. 3, an example of a TRP 300 may comprise a computing platform including a processor 310, a transceiver 320, and a memory 330 including software (SW) 332. The processor 310, the memory 330, and the transceiver 320 may be communicatively coupled to each other by a bus 380 (which may be configured, e.g., for optical and/or electrical communication). Even if referred to in the singular, the processor 310 may include one or more processors, the transceiver 320 may include one or more transceivers (e.g., one or more transmitters and/or one or more receivers), and the memory 330 may include one or more memories. One or more of the shown apparatus may be omitted from the TRP 300. The TRP 300 may be an example of any of the APs 220-223 and an example of the FS devices 210, 212.

The processor 310 may have any of various configurations. For example, the processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP (Digital Signal Processor), a modem processor, a video processor, and/or a sensor processor). The sensor processor may comprise, e.g., processors for RF (radio frequency) sensing (with one or more (cellular) wireless signals transmitted and reflection(s) used to identify, map, and/or track an object), and/or ultrasound, etc. The sensor processor may be configured to process satellite vehicle (SV) signals from one or more satellites for determining a location (possibly including a height (also called an elevation) relative to a reference level) of the TRP 300.

The memory 330 may be a non-transitory storage medium that may include random access memory (RAM)), flash memory, disc memory, and/or read-only memory (ROM), etc. The memory 330 may store the software 332 which may be processor-readable, processor-executable software code containing instructions that are configured to, when executed, cause the processor 310 to perform various functions described herein. Alternatively, the software 332 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 330) of the TRP 300 (and thus of one of the gNBs 110a, 110b and/or the ng-eNB 114) performing the function. The processor 310 may include a memory with stored instructions in addition to and/or instead of the memory 330. Functionality of the processor 310 is discussed more fully below.

The transceiver 320 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with a UE and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or another device.

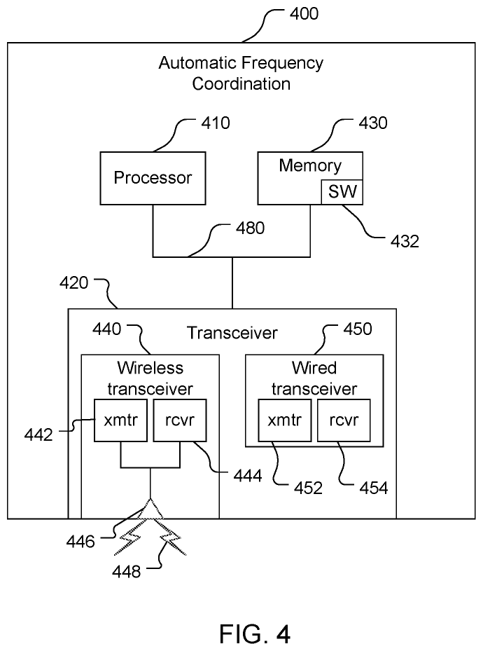

Referring also to FIG. 4, an example of an AFC 400 may comprise a computing platform including a processor 410, a transceiver 420, and a memory 430 including software (SW) 432. The processor 410, the memory 430, and the transceiver 420 may be communicatively coupled to each other by a bus 480 (which may be configured, e.g., for optical and/or electrical communication). Even if referred to in the singular, the processor 410 may include one or more processors, the transceiver 420 may include one or more transceivers (e.g., one or more transmitters and/or one or more receivers), and the memory 430 may include one or more memories. One or more of the shown apparatus (e.g., the transceiver 420) may be omitted from the AFC 400. The AFC 400 may be an example of the AFC 230, and may be separate from FS devices (e.g., the FS devices 210, 212) and APs (e.g., the APs 220-223), or may be incorporated into one or more APs and/or one or more FS devices.

The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor).

The memory 430 may be a non-transitory storage medium that may include random access memory (RAM)), flash memory, disc memory, and/or read-only memory (ROM), etc. The memory 430 may store the software 432 which may be processor-readable, processor-executable software code containing instructions that are configured to, when executed, cause the processor 410 to perform various functions described herein. Alternatively, the software 432 may not be directly executable by the processor 410 but may be configured to cause the processor 410, e.g., when compiled and executed, to perform the functions.

The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the AFC 400 performing a function as shorthand for one or more appropriate components of the AFC 400 performing the function. The processor 410 may include a memory with stored instructions in addition to and/or instead of the memory 430. Functionality of the processor 410 is discussed more fully below.

The transceiver 420 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with one or more access points, one or more UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the AFC 400 shown in FIG. 4 is an example and not limiting of the disclosure, including the claims, and other configurations may be used. For example, the wireless transceiver 440 may be omitted. Also or alternatively, the description herein discusses that the AFC 400 is configured to perform or performs several functions, but one or more of these functions may be performed by the TRP 300 and/or another device.

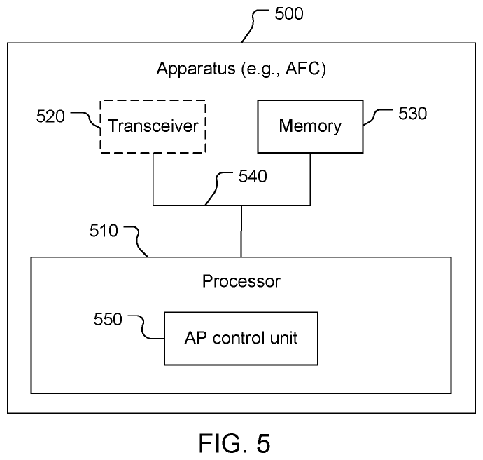

Referring also to FIG. 5, an apparatus 500 may include a processor 510, a transceiver 520, and a memory 530 communicatively coupled to each other by a bus 540. Even if referred to in the singular, the processor 510 may include one or more processors, the transceiver 520 may include one or more transceivers (e.g., one or more transmitters and/or one or more receivers), and the memory 530 may include one or more memories. The apparatus 500 may be an AFC, may include the components shown in FIG. 5, and may include one or more other components such as any of those shown in FIG. 4 such that the AFC 400 may be an example of the apparatus 500. For example, the transceiver 520 may be included and may include one or more of the components of the transceiver 420, e.g., the wireless transmitter 442 and the antenna 446, or the wireless receiver 444 and the antenna 446, or the wireless transmitter 442, the wireless receiver 444, and the antenna 446. Also or alternatively, the transceiver 520 may include the wired transmitter 452 and/or the wired receiver 454. The memory 530 may be configured similarly to the memory 430, e.g., including software with processor-readable instructions configured to cause the processor 510 to perform functions. The apparatus 500 may be a standalone device or may be included in another device such as the TRP 300 (e.g., an AP or an FS device) such that the memory 530 is a portion of the memory 330 and the processor 510 is a portion of the processor 310. The apparatus 500 may be part of a cloud service, with inputs from one or more APs and/or one or more FS devices.

The description herein may refer to the processor 510 performing a function, but this includes other implementations such as where the processor 510 executes software (stored in the memory 530) and/or firmware. The description herein may refer to the apparatus 500 performing a function as shorthand for one or more appropriate components (e.g., the processor 510 and the memory 530) of the apparatus 500 performing the function. The processor 510 (possibly in conjunction with the memory 530 and, as appropriate, the transceiver 520) may include an AP control unit 550. The AP control unit 550 may be configured to indicate for (e.g., request or instruct) an AP to avoid transmitting signals (i.e., not to transmit signals) in the same frequency band as an FS device, or at least to avoid transmitting such signals at standard power. The AP control unit 550 may be configured to make such an indication based on the AP interrupting the LOS (being in the LOS) of FS devices or being close enough to an FS device to interfere with signal transfer between FS devices. The AP control unit 550 is discussed further below, and the description may refer to the processor 510 generally, or the apparatus 500 generally, as performing any of the functions of the AP control unit 550, with the apparatus 500 being configured to perform the function(s).

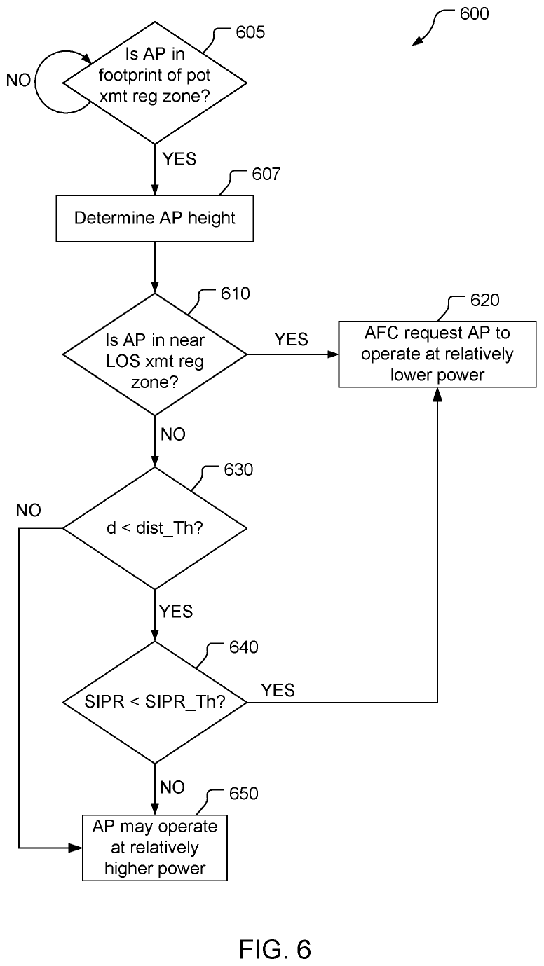

Referring also to FIG. 6, a method 600 of access point operation includes stages shown. The method 600 is, however, an example only and not limiting. The method 600 may be altered, e.g., by having one or more stages added, removed, rearranged, combined, performed concurrently, and/or by having one or more single stages split into multiple stages. The method 600 may be implemented in one or more devices, e.g., in an access point, in a combination of access points, in an AFC, in a combination of one or more access points and an AFC, etc. This discussion herein, however, assumes that the method 600 is performed primarily in the apparatus 500, with the apparatus 500 receiving, as appropriate, information obtained (e.g., measured) by one or more access points.

At stage 605, an inquiry is made as to whether a horizontal location of an AP is in a footprint of a potential signal transmission regulation zone such as the signal transmission regulation zone 260. The potential signal transmission regulation zone may include a volume of an actual signal transmission regulation zone in which signal transmission regulation is desired, and may include excess volume in which undesirable interference could theoretically be produced but that would not be produced in reality due to one or more device characteristics of one or more devices actually used. For example, the potential signal transmission regulation zone could include portions of the sphere 296 from which signal transmission could theoretically induce undesirable interference but from which would not actually create an undesirable SIPR in practice for the FS device 210 due to characteristics of a setup used (e.g., gain and power distribution function of the FS device 210, link length). If the horizontal location of the AP is outside of the footprint of the potential signal transmission regulation zone, then the method 600 repeats stage 605. If the horizontal location of the AP is within the footprint of the potential signal transmission regulation zone, and thus regulation of signal transmission by the AP is potentially desired, then the method 600 proceeds to stage 607.

At stage 607, a height of the AP is determined. For example, one or more techniques discussed above may be used to determine the heigh (elevation) of the AP in question such that it may be determined whether the AP is in a signal transmission regulation zone (e.g., on the LOS 270 between the devices 210, 212, or in the Fresnel Zone 280, or in an interference portion of the directional beam 290, or in the cylinder 294, or in the sphere 296 (or a portion thereof from which signal transmission, of at least a threshold power level, may induce undesired SIPR). The height may be determined from hardware, e.g., one or more sensors, of the AP (e.g., the AP 220 or the AP 221). If the APlacks hardware, e.g., an SPS receiver, for providing an accurate height (e.g., with cm-level accuracy), then one or more other positioning techniques may be used to determine the height(s) (elevation(s) relative to a reference level (e.g., mean sea level)) of the AP (e.g., the AP(s) 220, 221) with a better accuracy (e.g., finer resolution) than the AP is configured to determine.

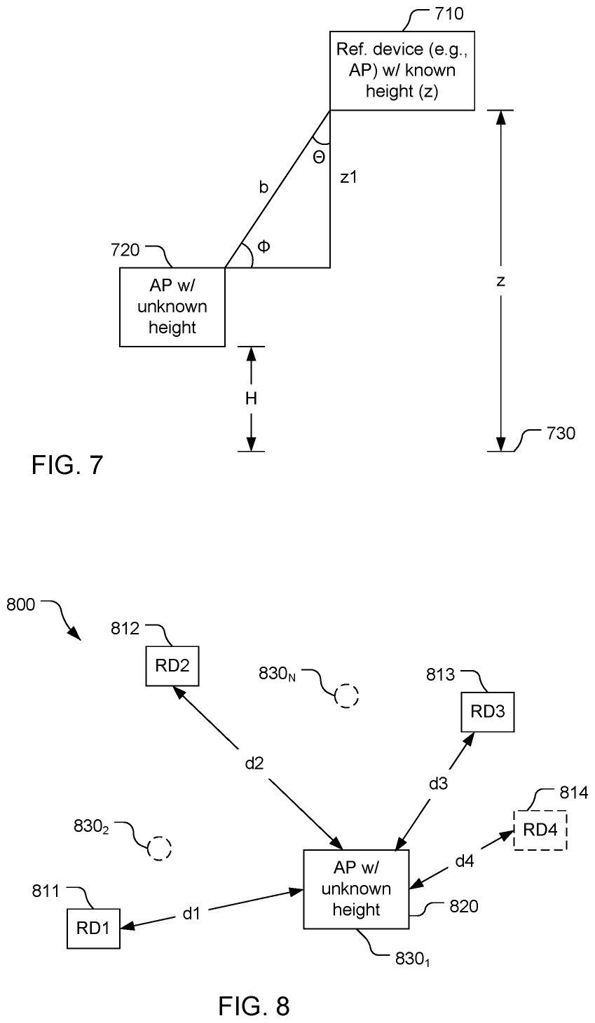

Referring also to FIG. 7, if a reference device 710 has a known location (including height), an AP 720 (e.g., the AP 220) whose height is to be determined supports AoA (Angle of Arrival) measurement, and at least one of the reference device 710 and the AP 720 supports ranging, then the height of the AP 720 may be determined. The reference device 710 may be another AP or another type of device. A height z of the reference device 710 may be known from one or more sources, e.g., measured and reported by an installer of the reference device 710, crowdsourced (e.g., by UEs), and/or measured by the reference device 710 (e.g., an SPS receiver in the reference device 710). The height z of the reference device 710 is a height relative to a reference level 730, e.g., mean sea level. The known height of the reference device 710 may be stored by the apparatus 500, and/or provided to the apparatus 500, e.g., upon request by the apparatus 500. A distance b between the reference device 710 and the AP 720 may be determined using any of a variety of known techniques (e.g., 802.11az ranging to cm-level accuracy). For example, a signal strength (e.g., RSSI) of a signal transmitted between the reference device 710 and the AP 720 may be measured. Knowing the transmit power of this signal, the distance b may be determined. As another example, an RTT may be determined by transmitting an initial signal from the reference device 710 to the AP 720 and transmitting a return signal from the AP 720 to the reference device 710 or vice versa, and subtracting a turnaround time from a difference between a time of transmission of the initial signal from one device and a time of reception of the return signal at that device. Knowing the RTT, the distance b may be calculated. Still other techniques may be used to determine the distance b. Further, if the AP 720 supports AoA detection, then an angle of arrival Φ of a signal received by the AP 720 from the reference device 710 may be measured by the AP 720. A device (e.g., the AP 720, the apparatus 500, etc.) may determine a height z1 of the AP 720 relative to the height z of the reference device 710 knowing the distance b and the angle Φ. The device may obtain the distance b and/or the angle Φ directly and/or indirectly (indirectly by obtaining one or more measurements and calculating/determining the distance b and/or the angle Φ). The device, e.g., the apparatus 500 (e.g., the AP control unit 550) may calculate the height z1 according to

$$z 1 = b * sin ( Φ ) \qquad ( 1 )$$

The height H of the AP 720 may be calculated according to

$$H = z - z 1 \qquad ( 2 )$$

Also or alternatively, if the reference device 710 supports AoA measurement, then the reference device 710 may measure (and possibly provide) an angle of arrival Θ of a signal received by the reference device 710 from the AP 720. The relative height z1 of the AP 720 relative to the reference device 710 may be calculated according to

$$z 1 = b * cos ( Θ ) \qquad ( 3 )$$

The height H of the AP 720 may be calculated according to Equation (2). The orientation of the reference device 710 or the AP 720 may be determined in order to determine the angle Θ or the angle Φ.

Referring to FIG. 8, with further reference to FIGS. 2 and 5, if reference devices 811, 812, 813 of an environment 800 have known locations (including heights), an AP 820 (e.g., the AP 220) whose height is to be determined may be calculated based on distances between the AP 820 and each of the reference devices 811-813. Each of the reference devices 811-813 may be another AP or another device. A height H of the AP 820 may be determined (e.g., by the AP 820, by the apparatus 500, and/or by another device) using trilateration, e.g., by solving Equations (4)-(6) to determine an intersection point of three spheres. The reference devices 811-833 have known locations of (x1, y1, z1), (x2, y2, z2), (x3, y3, z3), respectively. Distances d1, d2, d3 between the AP 820 and the reference devices 811-833, respectively, may be determined, e.g., by ranging (e.g., using RSSI and/or RTT, etc.). Knowing the distances d1, d2, d3, the location (x4, y4, z4) of the AP 820 may be determined by solving for these three unknowns in the following equations

$${( x 4 - x 1 )}^{2} + {( y 4 - y 1 )}^{2} + {( z 4 - z 1 )}^{2} = d {1}^{2} \qquad ( 4 )$$

$${( x 4 - x 2 )}^{2} + {( y 4 - y 2 )}^{2} + {( z 4 - z 2 )}^{2} = d {2}^{2} \qquad ( 5 )$$

$${( x 4 - x 3 )}^{2} + {( y 4 - y 3 )}^{2} + {( z 4 - z 3 )}^{2} = d {3}^{2} \qquad ( 6 )$$

The height H of the AP 820 may be determined in this way even if one or more (e.g., all) of the reference devices 811-813 does (do) not support AoA determination and/or the AP 820 does not support AoA determination. The reference devices 811-813 may be part of an enterprise network. In an enterprise network, a device (e.g., the AFC 400, a server, etc.) may gather and fuse location information for the reference devices 811-833, client information if available, and enterprise map information (e.g., of a building containing the reference devices 811-833 and the AP 820). Devices (e.g., APs and/or clients) in an enterprise network may share information (e.g., RTT measurements, CSI, longitude/latitude, etc.), e.g., to a cloud server and/or to a local server, and the server(s) may formulate a map by fusing collected data. This may facilitate better accuracy for a determination of the location of the AP 820. For example, map information, AP information (e.g., RTT measurements, RSSI measurements, sensing data, location data (e.g., latitude and longitude), and client (e.g., UE) information (e.g., RTT measurements, RSSI measurements, sensing data, location data (e.g., latitude and longitude)) may be obtained by an apparatus (e.g., a cloud server) such as the AFC 400 and used to determine the location (including height) of the AP 820.

As an extension of the determination of the location of the AP 820 using reference devices of known location, the location of the AP 820 may be determined by moving the AP 820 to a sufficient number of locations, using a sufficient number of reference devices of unknown location, and determining, for each of the locations of the AP 820, distances between the AP 820 and the reference devices. If there are M reference devices in the environment 800 each of unknown, three-dimensional location, then there are 3M unknown coordinates: {xⱼ, yⱼ, zⱼ}, j=1, 2, . . . , M. If the AP 820 is moved within the environment 800 to N locations 830₁, 830₂, . . . , 830_{N}, then at each location, there are three more unknown coordinates: {xᵢ, yᵢ, zᵢ}, i=1, 2, . . . , N. For each location, M distances are determined (e.g., by the AP 820) between the AP 820 and the reference devices, e.g., the reference devices 811-813 and the reference device 814 (and possibly one or more other reference devices (not shown)). Each determined distance may be used to form an equation

$${( {x}_{i} - {x}_{j} )}^{2} + {( {y}_{i} - {y}_{j} )}^{2} + {( {z}_{i} - {z}_{j} )}^{2} = {{d}_{ij}}^{2} \qquad ( 7 )$$

where i=1, 2, . . . , N and j=1, 2, . . . , M. Consequently, there are MN known distances, and 3M+3N unknown coordinates. With the AP 820 is moved to a sufficient quantity N of locations (N>>M), the location of the AP 820 may be solved for if there are at least four reference devices (M≥4). This is because if N>3M, then M being greater than or equal to four (4) means that

$$MN \geq 4 N > 3 N + 3 M \qquad ( 8 )$$

and thus that there are more equations than unknown coordinates. Using the determined distances alone, the apparatus 500 (and/or another device) may solve a 3D-location problem for all the reference devices and the AP 820 if enough distance measurements are available.

One or more other techniques for determining a height (and thus a full three-dimensional location) of the AP 220 may be used. For example, an approximate height may be calculated based on a height of a building on top of which the AP 220 is disposed.

Referring again in particular to FIG. 6, with an accurate height, and thus a full three-dimensional location, of the AP 220 being known, at stage 610, a determination may be made as to whether the AP 220 or the AP 221 is at least near LOS of a combination of devices, e.g., FS devices. For example, the AFC 230, e.g., the apparatus 500, may determine whether one or more APs, e.g., the AP 220 and/or the AP 221, are on the LOS 270 and/or in one or more signal transmission regulation zones that include the LOS 270 of the FS devices 210, 212 (any of which may be called a near-LOS signal transmission regulation zone), e.g., the Fresnel Zone 280, the directional beam 290 (or at least an interference portion thereof), and/or the cylinder 294. In order to determine whether one or more of the APs 220, 221 are in the LOS 270 of the FS devices 210, 212, i.e., in the LOS of the antennas 240, 242 of the FS devices 210, 212, and/or in a near-LOS signal transmission regulation zone, the apparatus 500 uses accurate heights of the APs 220, 221 obtained at stage 607 to determine three-dimensional locations of the APs 220, 221. The apparatus 500 compares the three-dimensional locations of the APs 220, 221 to locations forming the LOS 270 and/or to the volume(s) defining the near-LOS signal transmission regulation zone(s) to determine whether the APs 220, 221 are in the LOS 270 and/or in one or more of the near-LOS signal transmission regulation zones. If an AP, e.g., either of the APs 220, 221 in this example, is determined to be in the LOS 270 and/or in one or more of the near-LOS signal transmission regulation zones, then the method 600 proceeds to stage 620, and otherwise proceeds to stage 630.

At stage 620, the apparatus 500 (e.g., and AFC) may indicate for the AP determined to be LOS or near LOS with the FS devices (in this example, the AP 220) to operate at a relatively lower power (e.g., a lower power of two or more powers (i.e., not a highest power available (e.g., that the AP 220 is configured to use to transmit signals)), or below a threshold power, or below what is considered a standard power level), thus reducing potential interference with FS device communication, and improving FS device communication performance. For example, the apparatus 500 may transmit an indication (e.g., a request or an instruction) for the AP 220 to avoid transmitting potentially-interfering signals (e.g., signals at the same frequency, or a harmonic of the frequency, or in the same frequency band) as communication signals (at least potentially) transferred between the FS devices 210, 212. As another example, the apparatus 500 may transmit an indication (e.g., an instruction or a request) for the AP 220 to avoid transmitting potentially-interfering signals at a higher relative power, e.g., a higher of two powers, or a standard power, or above a threshold power. Thus, the indication may be for the AP 220 to vacate a channel or to transmit with a relatively lower transmission power level. A standard power is an allowed operating transmit power level, and is a power level that may cause interference, e.g., to an FS device. For example, in the United States, the FCC (Federal Communications Commission) authorized standard-power WiFi® 6E access points to operate in some frequency bands at transmit power levels up to 36 dBm EIRP (PSD of 23 dBm/MHz EIRP (Effective Isotropic Radiated Power)) and client devices or stations to operate at transmit power levels up to 30 dBM EIRP (PSD of 17 dBm/MHz EIRP). As examples regarding reduced power levels of operation, the FCC has authorized low-power WiFi® 6E access points to operate in the 6 GHz band at transmit power levels up to 30 dBM EIRP (PSD of 17 dBm/MHz EIRP) without AFC and client devices or stations to operate at up to 24 dBM EIRP (PSD of 11 dBm/MHz EIRP) without AFC. Consequently, standard power for 20 MHz-wide signal transmissions by access points may be considered to be above 18 dBm EIRP (e.g., between 18 dBm EIRP and 36 dBm EIRP), and for signal transmissions by client devices or stations may be considered to be above 12 dBm EIRP (e.g., between 12 dBm EIRP and 30 dBm EIRP), and reduced power for signal transmissions by access points may be considered to be below 18 dBm EIRP, and for signal transmissions by client devices or stations may be considered to be below 12 dBm EIRP. Table 1 below indicates examples of relatively low power levels (e.g., LPI (Low Power Indoor)) and relatively high power levels (e.g., SP (Standard Power)) for various example signal transmission bandwidths (BW).

TABLE 1

| BW (MHz) | LPI AP/LPI client (dBm) | SP AP/SP client (dBm) |
|---|---|---|
| 20 | 18/12 | 36/30 |
| 40 | 21/15 | 36/30 |
| 80 | 24/18 | 36/30 |
| 160 | 27/21 | 36/30 |
| 320 | 30/24 | 36/30 |

At stage 630, having determined that an AP (e.g., the AP 221) is not near LOS with a pair of FS devices (e.g., the FS devices 210, 212), an inquiry may be made as to whether a distance d between an FS device (e.g., the FS device 210) and an AP in question (e.g., the AP 221) is below a distance threshold dist_Th, e.g., whether the AP is in the sphere 296. For example, the apparatus 500 may obtain the distance d, e.g., receiving the distance d from the FS device 210 and/or the AP 221, or calculating the distance d from one or more measurements from the FS device 210 and/or the AP 221. The apparatus 500 may compare the obtained distance d with the distance threshold dist_Th (e.g., the radius 298). The distance threshold dist_Th may have a value such that if the distance d is above the distance threshold dist_Th, then the AP 221 is unlikely to interfere (at least significantly) with the FS device 210. The distance threshold dist_Th may be determined based on a characterization between SIPR (Signal-to-Interference Power Ratio) and d. The distance threshold dist_Th may depend on the FS device 210 and the combination of the FS devices 210, 212 as the threshold dist_Th may depend on the FS device characteristics C1-C4. The distance threshold dist_Th may, for example, be ten (10) times the link length C1. If the distance d is determined not to be below the distance threshold dist_Th, and thus unlikely that the AP 221 will interfere with the FS device 210, then the method 600 may proceed to stage 650. If the distance d is determined to be below the distance threshold dist_Th, and thus not unlikely that the AP 221 will interfere with the FS device 210, then the method 600 may proceed to stage 640. Alternatively, stage 640 may be omitted such that if the distance d is determined to be below the distance threshold dist_Th, and thus not unlikely that the AP 221 will interfere with the FS device 210, then the method 600 may proceed to stage 620 to have the AP transmit, if at all, with a relatively low transmit power. This may be a conservative approach, potentially regulating an AP to transmit with a relatively low power because the AP is within the distance threshold dist_Th even though the AP may be in a location such that the AP would not significantly interfere with the FS device 210 (e.g., due to being at a low-gain angle of the antenna 240 of the FS device 210).

At stage 640, having determined that an AP (e.g., the AP 221) is not near-LOS with a pair of FS devices (e.g., the FS devices 210, 212) but is within the distance threshold dist_Th of at least one of the FS devices, an inquiry may be made as to whether an SIPR (Signal to Interference Power Ratio) is below a SIPR threshold SIPR_Th. If a calculated SIPR is above the SIPR threshold SIPR_Th, then the AP 221 is unlikely to interfere (at least significantly) with the FS device 210 and the method 600 proceeds to stage 650. If the SIPR is below the SIPR threshold SIPR_Th, then the AP 221 is likely (or at least not unlikely) to interfere significantly with the FS device 210 and the method 600 proceeds to stage 620. A minimum value for the SIPR threshold SIPR_Th may be determined based on a governmental requirement.

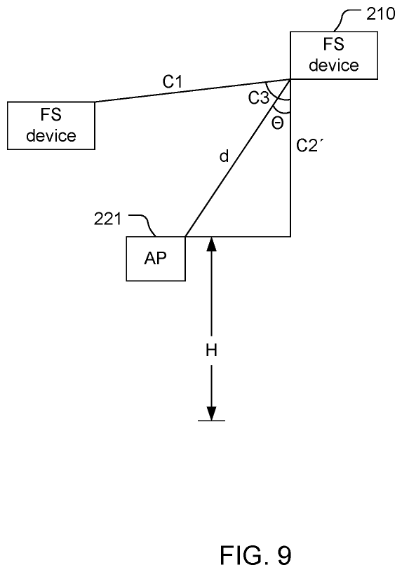

Referring also to FIG. 9, the apparatus 500, e.g., the AP control unit 550, and/or another device may determine the SIPR for a combination of the FS devices 210, 212 and the AP 221. The FS device characteristics C1-C4 may be maintained for each FS device, e.g., being stored in the memory 530 and/or in another device such as a cloud server. The discussion herein focuses on the apparatus 500 determining the SIPR and comparing the SIPR with the SIPR threshold SIPR_Th, but one or more other devices instead of, or in addition to and/or in combination with the apparatus 500, may be used to determine the SIPR and compare the SIPR with the SIPR threshold SIPR_Th. The apparatus 500 may obtain a height H of the AP 221 (e.g., as discussed above with respect to FIG. 7 and Equations (1)-(3)). The apparatus 500 may obtain (e.g., calculate) the distance d between the AP 221 and the FS device 210. The apparatus 500 may calculate the SIPR for the FS device 210 for the combination of the FS devices 210, 212 and the AP 221 according to

$$SIPR = \frac{{G}_{rx}^{FS} {P}_{rx}^{FS}}{{G}_{rx}^{AP} {P}_{rx}^{AP}} = \frac{C 4 ( C 3 ) F ( C 1 )}{C 4 ( Θ ) F ( d )} \qquad ( 9 )$$

$$cos ( Θ ) = \frac{C {2}^{′}}{d} \qquad ( 10 )$$

$$Θ = {cos}^{- 1} \frac{C {2}^{′}}{d} \qquad ( 11 )$$

$$C {2}^{′} = C 2 - H \qquad ( 12 )$$

where C2′ is the height of the AP 221 relative to the height of the FS device 210, Q is the elevation angle from the FS device 210 to the AP 221, Gᵣₓ^{ES} is the receive gain of the FS device 210, Pᵣₓ^{FS} is the received power (which is a function of the link length C1) at the FS device 210 of a signal from the FS device 212, Gᵣₓ^{AP} is the receive gain of the AP 221, Pᵣₓ^{AP} is the received power (which is a function of the distance d) at the FS device 210 of a signal from the AP 221, and F (C1) is the power distribution function of the FS device 210. The elevation angle Θ may be determined based on determination of the height differential z1 between the FS device 210 and the AP 221. In Equation (9), the numerator corresponds to an intended signal from an FS device to be transmitted and the denominator corresponds to a potentially interfering signal from an AP. The received power at the FS device 210 is given by

$${P}_{rx}^{FS} = {P}_{tx}^{FS} {G}_{rx}^{FS} {{G}_{tx}^{FS} ( \frac{λ}{4 π C 1} )}^{2} \qquad ( 13 )$$

where Pᵣₓ^{FS} is the transmit power from the FS device 210, and Gᵣₓ^{FS} is the gain of the FS device 210.

At stage 650, the AP 221 is allowed (or even instructed), e.g., by the apparatus 500, to operate with a relatively higher power, e.g., to transmit signals with a higher of two powers, or above a threshold power, e.g., a standard transmit power. Thus, the AP 221 may transmit, at the relatively higher transmit power level, a signal at the same frequency or at least in the same frequency band as communication signals transferred between the FS devices 210, 212. By implementing the method 600, before an AP transmits a signal that may interfere with a signal transfer between other devices (e.g., FS devices), a determination may be made that the AP will not (significantly) interfere with at least one of the FSes, and thus the AP may transmit with a relatively higher power (e.g., standard power), helping performance of the AP.

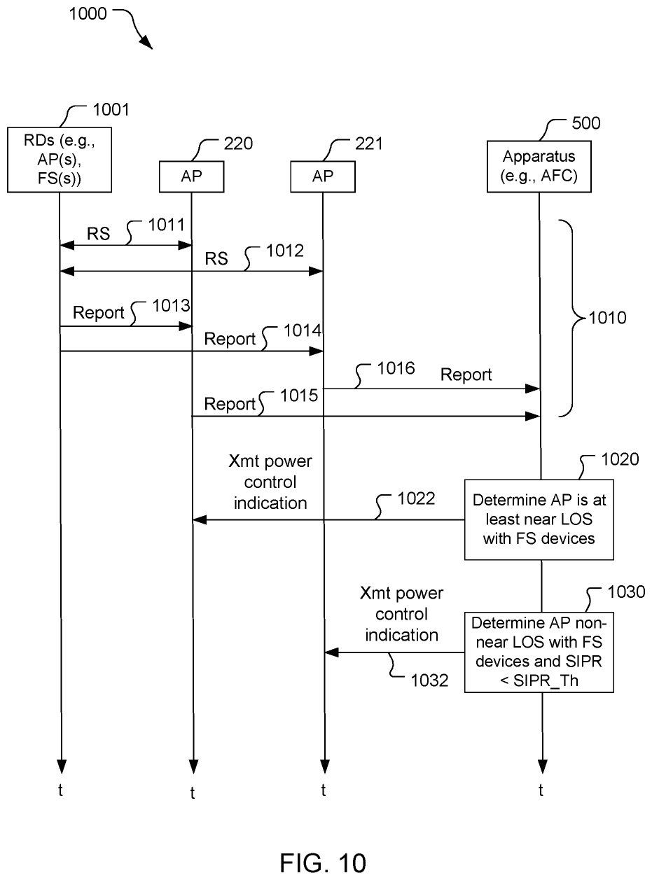

Referring also to FIG. 10, a signal and processing flow 1000 for controlling wireless communication device (e.g., access point) operation includes the stages shown. The flow 1000 is an example flow and not limiting. The flow 1000 may be altered, e.g., by having one or more messages and/or one or more stages added, removed, rearranged, combined, performed concurrently, and/or having one or more messages and/or one or more stages split into multiple messages and/or stages. In the flow 1000, RDs 1001 (Reference Devices), the AP 220, the AP 221, and the apparatus 500 may transfer signals as shown. The RDs 1001 may include one or more FS devices, one or more APs (possibly including the AP 220 and/or the AP 221), and/or one or more other devices capable of wireless signal transfer.

At stage 1010, signals are transferred between each of the APs 220, 221 and one or more other devices to obtain one or more measurements from which the location (e.g., height) of one or more of the APs 220, 221 may be obtained. The height(s) of the AP(s) 220, 221 may also be obtained. For example, the AP 220 and one or more of the RDs 1001 may transfer and measure one or more RS 1011 (Reference Signal(s)). Also or alternatively, the AP 221 and one or more of the RDs 1001 may transfer and measure one or more RS 1012. A measurement made by one of the RDs 1001 may be reported to the corresponding AP 220, 221 in one of reports 1013, 1014. The measurements may be used by the APs 220, 221 to determine distances between the APs 220, 221 and respective ones of the RDs 1001. The APs 220, 221 may use the distances to determine heights of the APs 220, 221 (e.g., as discussed with respect to FIG. 7 and Equations (1)-(3)). The APs 220, 221 may transmit reports 1015, 1016, respectively, to the apparatus 500, with each of the reports 1015, 1016 possibly including one or more signal measurements and/or a determined height of the respective AP 220, 221.

At stage 1020, the apparatus 500, e.g., the AP control unit 550, may determine that the AP 220 is at least near LOS with the FS devices 210, 212. For example, at stages 605, 607, 610 the apparatus 500 may use information obtained at stage 1010 to determine that the horizontal location of the AP 220 is within a footprint of the LOS 270 or the footprint of one or more near-LOS transmission regulation zones of the signal transmission regulation zone 260, determine the height of the AP 220, and determine whether the AP 220 intersects the LOS 270 or is in one or more of the near-LOS transmission regulation zones. Based on determining that the AP 220 is at least near LOS (i.e., LOS or near LOS) with the FS devices 210, 212, the apparatus 500 may transmit a transmit power control indication 1022 to the AP 220 (e.g., at stage 620) to regulate a transmit power used by the AP 220. For example, the indication 1022 may be for the AP 220 (at least for potentially-interfering signals (e.g., signals of the same frequency as, or same frequency band as, or a harmonic of, signals (at least possibly) transferred between the FS devices 210, 212)) not to transmit or to transmit at a relatively-lower transmit power (e.g., at a lower power option instead of a higher power option, or below a power threshold, etc.).

At stage 1030, the apparatus 500, e.g., the AP control unit 550, may determine that the AP 221 is not near LOS with the FS devices 210, 212 and determine that a corresponding SIPR is below the SIPR threshold SIPR_Th. For example, at stages 605, 607, 610 the apparatus 500 may use information obtained at stage 1010 to determine that the AP 221 is ot near LOS with the FS devices 210, 212. Based on determining that the AP 221 is NLOS with the FS devices 210, 212, at stage 630 the apparatus 500 may determine whether a distance between the FS device 210 and the AP 221 is below the distance threshold dist_Th, e.g., is less than the radius 298, such that there is potential for a corresponding SIPR to be below the SIPR threshold. Based on determining that the distance between the FS device 210 and the AP 221 is below the distance threshold dist_Th, the apparatus 500 may determine a SIPR (e.g., retrieving stored FS device characteristics as appropriate) and determine (e.g., at stage 640) whether the SIPR is below the SIPR threshold SIPR_Th. Alternatively, the apparatus 500 may determine a SIPR (e.g., retrieving stored FS device characteristics as appropriate) and determine (e.g., at stage 640) whether the SIPR is below the SIPR threshold SIPR_Th regardless of the distance d (e.g., relative to the distance threshold dist_Th). Based on the SIPR being below the SIPR threshold, the apparatus 500 may transmit a transmit power control indication 1032 to the AP 221 (e.g., at stage 620) to regulate a transmit power used by the AP 221. For example, the indication 1032 may be for the AP 221 (at least for potentially-interfering signals) not to transmit or to transmit at a relatively-lower transmit power (e.g., at a lower power option instead of a higher power option, or below a power threshold, etc.). Interference with FS device communication may thus be avoided while also helping to ensure good AP operation (e.g., by allowing standard power operation where an AP does not or is at least not likely to interfere with FS device communication). While the discussion of stage 1030 focused on the AP 221 and the FS device 210 as an example, the analysis may be applied to other APs and to other FS devices (e.g., the FS device 212), and/or may be applied to other types of apparatus (e.g., in addition to or instead of APs and/or in addition to or instead of FS devices).

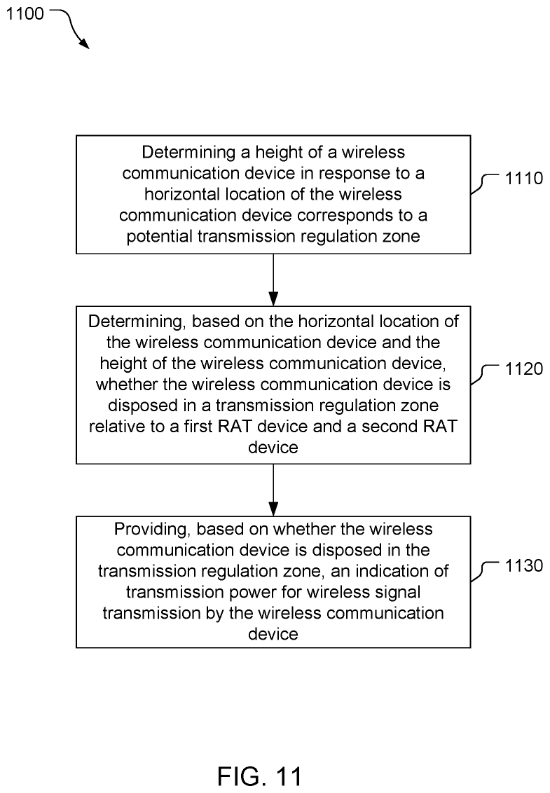

Referring to FIG. 11, with further reference to FIGS. 1-10, a method 1100 of controlling wireless communication device operation includes the stages shown. The method 1100 is, however, an example only and not limiting. The method 1100 may be altered, e.g., by having one or more stages added and/or by having a single stage split into multiple stages.

At stage 1110, the method 1100 includes: determining a height of a wireless communication device in response to a horizontal location of the wireless communication device corresponds to a potential transmission regulation zone. For example, at stage 605, the apparatus 500 may determine that a horizontal location of a wireless communication device such as an AP (e.g., the APs 220, 221, are within a footprint of the signal transmission regulation zone 260, and in response to that, at stage 607, determine the height of the wireless communication device (e.g., the heights of the APs 220, 221). The apparatus 500 may coordinate with one or more other devices, e.g., the APs 220, 221 and possibly one or more other devices (e.g., one or more other APs), to determine the heigh of the wireless communication device. The processor 510 (e.g., the processor 310 or the processor 410), possibly in combination with the memory 530 (e.g., the memory 330 or the memory 430), possibly in combination with the transceiver 520 (e.g., the transceiver 320 or the transceiver 420) may comprise means for determining a height of the wireless communication device.

At stage 1120, the method 1100 includes: determining, based on the horizontal location of the wireless communication device and the height of the wireless communication device, whether the wireless communication device is disposed in a transmission regulation zone relative to a first RAT device (first Radio Access Technology device) and a second RAT device. For example, the apparatus 500 may compare the three-dimensional location of the wireless communication device (e.g., the APs 220, 221) to an LOS such as the LOS 270 and/or to one or more volumes corresponding to one or more signal transmission regulation zones (e.g., the Fresnel Zone 280, the directional beam 290, the cylinder 294, the sphere 296, or a SIPR region) to determine whether the wireless communication device is in a transmission regulation zone relative to the first and second RATs, e.g., the FS devices 210, 212. The processor 510 (e.g., the processor 310 or the processor 410), possibly in combination with the memory 530 (e.g., the memory 330 or the memory 430), may comprise means for determining whether the wireless communication device is disposed in a transmission regulation zone.

At stage 1130, the method 1100 includes providing, based on whether the wireless communication device is disposed in the transmission regulation zone, an indication of transmission power for wireless signal transmission by the wireless communication device. For example, at stage 620 (from stage 610) or at stage 1020, the apparatus 500 may provide (e.g., transmit to the AP 220 (e.g., from an FS device, from an AP, from a server, or from another device) or transmit from one portion of the AP 220 to another portion of the AP 220) an indication (e.g., the indication 1022) to regulate transmit power of the AP 220 (e.g., indicating for the AP 220 not to transmit, not to transmit at standard power, or to transmit at a relatively-lower power, a signal that may interfere with a signal wirelessly transmitted by an FS device. Also or alternatively, at stage 620 (from stage 640) or at stage 1030, the apparatus 500 may provide (e.g., transmit to the AP 221 (e.g., from an FS device, from an AP, from a server, or from another device) or transmit from one portion of the AP 221 to another portion of the AP 221) an indication (e.g., the indication 1032) for the AP 221 not to transmit, not to transmit at standard power, or to transmit at a relatively-lower power, a signal that may interfere with a signal wirelessly transmitted by an FS device. The processor 510 (e.g., the processor 310 or the processor 410), possibly in combination with the memory 530 (e.g., the memory 330 or the memory 430), possibly in combination with the transceiver 520 (e.g., the transceiver 320 or the transceiver 420) may comprise means for providing the indication.

Implementations of the method 1100 may include one or more of the following features. In an example implementation, determining whether the wireless communication device is disposed in the transmission regulation zone comprises determining at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device. For example, the determining at stage 1120 may involve the apparatus determining at stage 610 whether any of the APs 220, 221 are LOS to the FS devices 210, 212, or in a near-LOS transmission regulation zone (e.g., the Fresnel Zone 280, the directional beam 290, the cylinder 294, or the sphere 296, or a SIPR region (e.g., within the sphere 296), etc.). The processor 510 (e.g., the processor 310 or the processor 410), possibly in combination with the memory 530 (e.g., the memory 330 or the memory 430), may comprise means for determining at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region. In another example implementation, the indication indicates for the wireless communication device to avoid transmitting signals in a frequency band in which the first RAT device and the second RAT device are licensed to transmit communication signals. For example, the indication may thus indicate not to transmit signals in a frequency band used or licensed by the RAT devices, e.g., the FS devices 210, 212. In another example implementation, the indication indicates for the wireless communication device to transmit signals, in a frequency band in which the first RAT device and the second RAT device are licensed to transmit communication signals, at a lower power level from among at least the lower power level and a higher power level that the wireless communication device is configured to use for wireless signal transmission. This may help avoid interference with FS device communications while still permitting AP operation. The indication may indicate to transmit at a lower power level (e.g., below a threshold power level) in a frequency band used by the RAT devices, or at a frequency that may interfere with (e.g., is a harmonic of) a frequency used by the RAT devices. In another example implementation, determining the height of the wireless communication device includes determining the height of the wireless communication device based on a height of a reference device and an angle of arrival of a reference signal transmitted between the wireless communication device and the reference device. For example, the apparatus 500 (e.g., the AP control unit 550) may determine a height of an AP (e.g., the AP 220 or the AP 221) based on the angle Φ or the angle Θ, and the Equations (1) and (2), or the Equations (2) and (3), respectively. In this way, AP location may be determined even without the AP having location hardware (e.g., an SPS receiver), enabling LOS/NLOS status relative to FS devices to determined, such that AP operation may be controlled as appropriate to avoid FS device communication interference. The processor 510, possibly in combination with the memory 530, possibly in combination with the transceiver 520 (e.g., the wireless receiver 444 and the antenna 446, and/or the wired receiver 454) may comprise means for determining the height of the wireless communication device. In another example implementation, determining the heigh of the wireless communication device includes determining the height of the wireless communication device based on distances between the wireless communication device and at least three reference devices with known three-dimensional locations. For example, the apparatus 500 (e.g., the AP control unit 550) may determine a height of an AP (e.g., the AP 220 or the AP 221) based on measured distances between the AP and three reference devices, and the Equations (4)-(6). In this way, AP location may be determined even without the AP having location hardware or an ability to measure angle of arrival, enabling LOS/NLOS status relative to FS devices to be determined, such that AP operation may be controlled as appropriate to avoid FS device communication interference. The processor 510, possibly in combination with the memory 530, possibly in combination with the transceiver 520 (e.g., the wireless receiver 444 and the antenna 446, and/or the wired receiver 454) may comprise means for determining the height. In another example implementation, determining the height of the wireless communication device includes determining the height of the wireless communication device based on distances between the wireless communication device and at least M reference devices with the wireless communication device at each of N locations, where M≥4 and N>3M. For example, the apparatus 500 (e.g., the AP control unit 550) may determine a height of an AP (e.g., the AP 220 or the AP 221) based on measured distances between the AP and M reference devices at each of N locations of the AP, and the Equations (7) and (8). In this way, AP location may be determined even without the AP having location hardware or an ability to measure angle of arrival and without knowing reference device locations, enabling LOS/NLOS status relative to FS devices to be determined, such that AP operation may be controlled as appropriate to avoid FS device communication interference. The processor 510, possibly in combination with the memory 530, possibly in combination with the transceiver 520 (e.g., the wireless receiver 444 and the antenna 446, and/or the wired receiver 454) may comprise means for determining the height.

Also or alternatively, implementations of the method 1100 may include one or more of the following features. In an example implementation, determining whether the wireless communication device is disposed in the transmission regulation zone includes: determining whether the wireless communication device is within a threshold distance of the first RAT device; and determining, in response to determining that the wireless communication device is within the threshold distance of the first RAT device, whether the wireless communication device is in a SIPR region (Signal-to-Interference Power Ratio region) within which signal transmission by the wireless communication device may induce an unacceptable SIPR for the first RAT device. For example, the apparatus 500 may determine, at stage 630, whether the AP 221 is within the sphere 296 and in response to determining that the AP 221 is within the sphere 296 determining, at stage 640, whether the SIPR corresponding to the AP 221 and the FS devices 210, 212 is less than the SIPR threshold. The processor 510 (e.g., the processor 310 or the processor 410), possibly in combination with the memory 530 (e.g., the memory 330 or the memory 430), may comprise means for determining whether the wireless communication device is within the threshold distance and means for determining whether the wireless communication device is in the SIPR region. In a further example implementation, the threshold distance depends on at least one of: a separation distance between the first RAT device and the second RAT device; a height of an antenna of the first RAT device; an elevation angle of the second RAT device relative to the first RAT device; and a gain of the antenna of the first RAT device. For example, the apparatus 500 may retrieve FS device characteristics from the memory 530 for the FS device 210, for signal transfer to and/or from the FS device 212, and determine the threshold distance from the FS device characteristics.

### IMPLEMENTATION EXAMPLES

Implementation examples are provided in the following numbered clauses.

Clause 1. A method of controlling wireless communication device operation, the method comprising:
determining a height of a wireless communication device in response to a horizontal location of the wireless communication device corresponding to a potential transmission regulation zone;
determining, based on the horizontal location of the wireless communication device and the height of the wireless communication device, whether the wireless communication device is disposed in a transmission regulation zone relative to a first RAT device (first Radio Access Technology device) and a second RAT device; and
providing, based on whether the wireless communication device is disposed in the transmission regulation zone, an indication of transmission power for wireless signal transmission by the wireless communication device.

Clause 2. The method of clause 1, wherein determining whether the wireless communication device is disposed in the transmission regulation zone comprises determining at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device.

Clause 3. The method of clause 1, wherein the indication indicates for the wireless communication device to avoid transmitting signals in a frequency band in which the first RAT device and the second RAT device are licensed to transmit communication signals.

Clause 4. The method of clause 1, wherein the indication indicates for the wireless communication device to transmit signals, in a frequency band in which the first RAT device and the second RAT device are licensed to transmit communication signals, at a lower power level from among at least the lower power level and a higher power level that the wireless communication device is configured to use for wireless signal transmission.

Clause 5. The method of clause 1, wherein determining the height of the wireless communication device comprises determining the height of the wireless communication device based on a height of a reference device and an angle of arrival of a reference signal transmitted between the wireless communication device and the reference device.

Clause 6. The method of clause 1, wherein determining the height of the wireless communication device comprises determining the height of the wireless communication device based on distances between the wireless communication device and at least three reference devices with known three-dimensional locations.

Clause 7. The method of clause 1, wherein determining the height of the wireless communication device comprises determining the height of the wireless communication device based on distances between the wireless communication device and at least M reference devices with the wireless communication device at each of N locations, where M≥4 and N>3M.

Clause 8. The method of clause 1, wherein determining whether the wireless communication device is disposed in the transmission regulation zone comprises:
determining whether the wireless communication device is within a threshold distance of the first RAT device; and
determining, in response to determining that the wireless communication device is within the threshold distance of the first RAT device, whether the wireless communication device is in a SIPR region (Signal-to-Interference Power Ratio region) within which signal transmission by the wireless communication device may induce an unacceptable SIPR for the first RAT device.

Clause 9. The method of clause 8, wherein the threshold distance depends on at least one of: a separation distance between the first RAT device and the second RAT device; a height of an antenna of the first RAT device; an elevation angle of the second RAT device relative to the first RAT device; and a gain of the antenna of the first RAT device.

Clause 10. An apparatus comprising:
at least one transceiver;
at least one memory; and
at least one processor, communicatively coupled to the at least one transceiver and the at least one memory, configured to:
   determine a height of a wireless communication device in response to a horizontal location of the wireless communication device corresponding to a potential transmission regulation zone;
   determine, based on the horizontal location of the wireless communication device and the height of the wireless communication device, whether the wireless communication device is disposed in a transmission regulation zone relative to a first RAT device (first Radio Access Technology device) and a second RAT device; and
   provide, based on whether the wireless communication device is disposed in the transmission regulation zone, an indication of transmission power for wireless signal transmission by the wireless communication device.

Clause 11. The apparatus of clause 10, wherein to determine whether the wireless communication device is disposed in the transmission regulation zone the at least one processor is configured to determine at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device.

Clause 12. The apparatus of clause 10, wherein the indication indicates for the wireless communication device to avoid transmitting signals in a frequency band in which the first RAT device and the second RAT device are licensed to transmit communication signals.

Clause 13. The apparatus of clause 10, wherein the indication indicates for the wireless communication device to transmit signals, in a frequency band in which the first RAT device and the second RAT device are licensed to transmit communication signals, at a lower power level from among at least the lower power level and a higher power level that the wireless communication device is configured to use for wireless signal transmission.

Clause 14. The apparatus of clause 10, wherein to determine the height of the wireless communication device the at least one processor is configured to determine the height of the wireless communication device based on a height of a reference device and an angle of arrival of a reference signal transmitted between the wireless communication device and the reference device.

Clause 15. The apparatus of clause 10, wherein to determine the height of the wireless communication device the at least one processor is configured to determine the height of the wireless communication device based on distances between the wireless communication device and at least three reference devices with known three-dimensional locations.

Clause 16. The apparatus of clause 10, wherein to determine the height of the wireless communication device the at least one processor is configured to determine the height of the wireless communication device based on distances between the wireless communication device and at least M reference devices with the wireless communication device at each of N locations, where M≥4 and N>3M.

Clause 17. The apparatus of clause 10, wherein to determine whether the wireless communication device is disposed in the transmission regulation zone the at least one processor is configured to:
determine whether the wireless communication device is within a threshold distance of the first RAT device; and
determine, in response to determining that the wireless communication device is within the threshold distance of the first RAT device, whether the wireless communication device is in a SIPR region (Signal-to-Interference Power Ratio region) within which signal transmission by the wireless communication device may induce an unacceptable SIPR for the first RAT device.

Clause 18. The apparatus of clause 17, wherein the threshold distance depends on at least one of: a separation distance between the first RAT device and the second RAT device; a height of an antenna of the first RAT device; an elevation angle of the second RAT device relative to the first RAT device; and a gain of the antenna of the first RAT device.

Clause 19. An apparatus comprising:
means for determining a height of a wireless communication device in response to a horizontal location of the wireless communication device corresponding to a potential transmission regulation zone;
means for determining, based on the horizontal location of the wireless communication device and the height of the wireless communication device, whether the wireless communication device is disposed in a transmission regulation zone relative to a first RAT device (first Radio Access Technology device) and a second RAT device; and
means for providing, based on whether the wireless communication device is disposed in the transmission regulation zone, an indication of transmission power for wireless signal transmission by the wireless communication device.

Clause 20. The apparatus of clause 19, wherein the means for determining whether the wireless communication device is disposed in the transmission regulation zone comprise means for determining at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device.

Clause 21. The apparatus of clause 19, wherein the indication indicates for the wireless communication device to avoid transmitting signals in a frequency band in which the first RAT device and the second RAT device are licensed to transmit communication signals.

Clause 22. The apparatus of clause 19, wherein the indication indicates for the wireless communication device to transmit signals, in a frequency band in which the first RAT device and the second RAT device are licensed to transmit communication signals, at a lower power level from among at least the lower power level and a higher power level that the wireless communication device is configured to use for wireless signal transmission.

Clause 23. The apparatus of clause 19, wherein the means for determining the height of the wireless communication device comprise means for determining the height of the wireless communication device based on a height of a reference device and an angle of arrival of a reference signal transmitted between the wireless communication device and the reference device.

Clause 24. The apparatus of clause 19, wherein the means for determining the height of the wireless communication device comprise means for determining the height of the wireless communication device based on distances between the wireless communication device and at least three reference devices with known three-dimensional locations.

Clause 25. The apparatus of clause 19, wherein the means for determining the height of the wireless communication device comprise means for determining the height of the wireless communication device based on distances between the wireless communication device and at least M reference devices with the wireless communication device at each of N locations, where M≥4 and N>3M.

Clause 26. The apparatus of clause 19, wherein the means for determining whether the wireless communication device is disposed in the transmission regulation zone comprise:
means for determining whether the wireless communication device is within a threshold distance of the first RAT device; and
means for determining, in response to determining that the wireless communication device is within the threshold distance of the first RAT device, whether the wireless communication device is in a SIPR region (Signal-to-Interference Power Ratio region) within which signal transmission by the wireless communication device may induce an unacceptable SIPR for the first RAT device.

Clause 27. The apparatus of clause 26, wherein the threshold distance depends on at least one of: a separation distance between the first RAT device and the second RAT device; a height of an antenna of the first RAT device; an elevation angle of the second RAT device relative to the first RAT device; and a gain of the antenna of the first RAT device.

Clause 28. A non-transitory, processor-readable storage medium comprising processor-readable instructions to cause at least one processor of an apparatus to:
determine a height of a wireless communication device in response to a horizontal location of the wireless communication device corresponding to a potential transmission regulation zone;
determine, based on the horizontal location of the wireless communication device and the height of the wireless communication device, whether the wireless communication device is disposed in a transmission regulation zone relative to a first RAT device (first Radio Access Technology device) and a second RAT device; and
provide, based on whether the wireless communication device is disposed in the transmission regulation zone, an indication of transmission power for wireless signal transmission by the wireless communication device.

Clause 29. The non-transitory, processor-readable storage medium of clause 28, wherein the processor-readable instructions to cause the at least one processor to determine whether the wireless communication device is disposed in the transmission regulation zone comprise processor-readable instructions to cause the at least one processor to determine at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device.

Clause 30. The non-transitory, processor-readable storage medium of clause 28, wherein the indication indicates for the wireless communication device to avoid transmitting signals in a frequency band in which the first RAT device and the second RAT device are licensed to transmit communication signals.

Clause 31. The non-transitory, processor-readable storage medium of clause 28, wherein the indication indicates for the wireless communication device to transmit signals, in a frequency band in which the first RAT device and the second RAT device are licensed to transmit communication signals, at a lower power level from among at least the lower power level and a higher power level that the wireless communication device is configured to use for wireless signal transmission.

Clause 32. The non-transitory, processor-readable storage medium of clause 28, wherein the processor-readable instructions to cause the at least one processor to determine the height of the wireless communication device comprise processor-readable instructions to cause the at least one processor to determine the height of the wireless communication device based on a height of a reference device and an angle of arrival of a reference signal transmitted between the wireless communication device and the reference device.

Clause 33. The non-transitory, processor-readable storage medium of clause 28, wherein the processor-readable instructions to cause the at least one processor to determine the height of the wireless communication device comprise processor-readable instructions to cause the at least one processor to determine the height of the wireless communication device based on distances between the wireless communication device and at least three reference devices with known three-dimensional locations.

Clause 34. The non-transitory, processor-readable storage medium of clause 28, wherein the processor-readable instructions to cause the at least one processor to determine the height of the wireless communication device comprise processor-readable instructions to cause the at least one processor to determine the height of the wireless communication device based on distances between the wireless communication device and at least M reference devices with the wireless communication device at each of N locations, where M≥4 and N>3M.

Clause 35. The non-transitory, processor-readable storage medium of clause 28, wherein the processor-readable instructions to cause the at least one processor to determine whether the wireless communication device is disposed in the transmission regulation zone comprise processor-readable instructions to cause the at least one processor to:
determine whether the wireless communication device is within a threshold distance of the first RAT device; and
determine, in response to determining that the wireless communication device is within the threshold distance of the first RAT device, whether the wireless communication device is in a SIPR region (Signal-to-Interference Power Ratio region) within which signal transmission by the wireless communication device may induce an unacceptable SIPR for the first RAT device.

Clause 36. The non-transitory, processor-readable storage medium of clause 35, wherein the threshold distance depends on at least one of: a separation distance between the first RAT device and the second RAT device; a height of an antenna of the first RAT device; an elevation angle of the second RAT device relative to the first RAT device; and a gain of the antenna of the first RAT device.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of controlling wireless communication device operation, the method comprising:
determining a height of a wireless communication device in response to a horizontal location of the wireless communication device corresponding to a potential transmission regulation zone;
determining, based on the horizontal location of the wireless communication device and the height of the wireless communication device, whether the wireless communication device is disposed in a transmission regulation zone relative to a first RAT device (first Radio Access Technology device) and a second RAT device; and
providing, based on whether the wireless communication device is disposed in the transmission regulation zone, an indication of transmission power for wireless signal transmission by the wireless communication device.

2. The method of claim 1, wherein determining whether the wireless communication device is disposed in the transmission regulation zone comprises determining at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device.

3. The method of claim 1, wherein the indication indicates for the wireless communication device to avoid transmitting signals in a frequency band in which the first RAT device and the second RAT device are licensed to transmit communication signals.

4. The method of claim 1, wherein the indication indicates for the wireless communication device to transmit signals, in a frequency band in which the first RAT device and the second RAT device are licensed to transmit communication signals, at a lower power level from among at least the lower power level and a higher power level that the wireless communication device is configured to use for wireless signal transmission.

5. The method of claim 1, wherein determining the height of the wireless communication device comprises determining the height of the wireless communication device based on a height of a reference device and an angle of arrival of a reference signal transmitted between the wireless communication device and the reference device.

6. The method of claim 1, wherein determining the height of the wireless communication device comprises determining the height of the wireless communication device based on distances between the wireless communication device and at least three reference devices with known three-dimensional locations.

7. The method of claim 1, wherein determining the height of the wireless communication device comprises determining the height of the wireless communication device based on distances between the wireless communication device and at least M reference devices with the wireless communication device at each of N locations, where M≥4 and N>3M.

8. The method of claim 1, wherein determining whether the wireless communication device is disposed in the transmission regulation zone comprises:
determining whether the wireless communication device is within a threshold distance of the first RAT device; and
determining, in response to determining that the wireless communication device is within the threshold distance of the first RAT device, whether the wireless communication device is in a SIPR region (Signal-to-Interference Power Ratio region) within which signal transmission by the wireless communication device may induce an unacceptable SIPR for the first RAT device.

9. The method of claim 8, wherein the threshold distance depends on at least one of: a separation distance between the first RAT device and the second RAT device; a height of an antenna of the first RAT device; an elevation angle of the second RAT device relative to the first RAT device; and a gain of the antenna of the first RAT device.

10. An apparatus comprising:
at least one transceiver;
at least one memory; and
at least one processor, communicatively coupled to the at least one transceiver and the at least one memory, configured to:
determine a height of a wireless communication device in response to a horizontal location of the wireless communication device corresponding to a potential transmission regulation zone;
determine, based on the horizontal location of the wireless communication device and the height of the wireless communication device, whether the wireless communication device is disposed in a transmission regulation zone relative to a first RAT device (first Radio Access Technology device) and a second RAT device; and
provide, based on whether the wireless communication device is disposed in the transmission regulation zone, an indication of transmission power for wireless signal transmission by the wireless communication device.

11. The apparatus of claim 10, wherein to determine whether the wireless communication device is disposed in the transmission regulation zone the at least one processor is configured to determine at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device.

12. The apparatus of claim 10, wherein the indication indicates for the wireless communication device to avoid transmitting signals in a frequency band in which the first RAT device and the second RAT device are licensed to transmit communication signals.

13. The apparatus of claim 10, wherein the indication indicates for the wireless communication device to transmit signals, in a frequency band in which the first RAT device and the second RAT device are licensed to transmit communication signals, at a lower power level from among at least the lower power level and a higher power level that the wireless communication device is configured to use for wireless signal transmission.

14. The apparatus of claim 10, wherein to determine the height of the wireless communication device the at least one processor is configured to determine the height of the wireless communication device based on a height of a reference device and an angle of arrival of a reference signal transmitted between the wireless communication device and the reference device.

15. The apparatus of claim 10, wherein to determine the height of the wireless communication device the at least one processor is configured to determine the height of the wireless communication device based on distances between the wireless communication device and at least three reference devices with known three-dimensional locations.

16. The apparatus of claim 10, wherein to determine the height of the wireless communication device the at least one processor is configured to determine the height of the wireless communication device based on distances between the wireless communication device and at least M reference devices with the wireless communication device at each of N locations, where M≥4 and N>3M.

17. The apparatus of claim 10, wherein to determine whether the wireless communication device is disposed in the transmission regulation zone the at least one processor is configured to:
determine whether the wireless communication device is within a threshold distance of the first RAT device; and
determine, in response to determining that the wireless communication device is within the threshold distance of the first RAT device, whether the wireless communication device is in a SIPR region (Signal-to-Interference Power Ratio region) within which signal transmission by the wireless communication device may induce an unacceptable SIPR for the first RAT device.

18. The apparatus of claim 17, wherein the threshold distance depends on at least one of: a separation distance between the first RAT device and the second RAT device; a height of an antenna of the first RAT device; an elevation angle of the second RAT device relative to the first RAT device; and a gain of the antenna of the first RAT device.

19. An apparatus comprising:
means for determining a height of a wireless communication device in response to a horizontal location of the wireless communication device corresponding to a potential transmission regulation zone;
means for determining, based on the horizontal location of the wireless communication device and the height of the wireless communication device, whether the wireless communication device is disposed in a transmission regulation zone relative to a first RAT device (first Radio Access Technology device) and a second RAT device; and
means for providing, based on whether the wireless communication device is disposed in the transmission regulation zone, an indication of transmission power for wireless signal transmission by the wireless communication device.

20. The apparatus of claim 19, wherein the means for determining whether the wireless communication device is disposed in the transmission regulation zone comprise means for determining at least one of whether the wireless communication device is in a line of sight between the first RAT device and the second RAT device, or whether the wireless communication device is in a near-line-of-sight transmission regulation zone relative to the first RAT device and the second RAT device, or whether the wireless communication device is in a SIPR region (Signal-to-Interference Power Ratio region) within which signal transmission by the wireless communication device may induce an unacceptable SIPR for the first RAT device.
